(19) United States
(12) Patent Application Publication
(10) Pub. No.: US 2012/0324359 A1
(43) Pub. Date: Dec. 20, 2012

(54) Systems and Methods for Monitoring and Enhancing Software Applications

(75) Inventors: Thomas Shih-Chun Lee, Elmhurst, IL (US); Timothy D. Hansen, St. Charles, IL (US)

(73) Assignee: SA IGNITE, INC., Elmhurst, IL (US)

(21) Appl. No.: 13/576,777

(22) PCT Filed: Feb. 18, 2011
(86) PCT No.: PCT/US11/25435

§ 371 Date: Aug. 27, 2012

Related U.S. Application Data
(60) Provisional application No. 61/338,343, filed on Feb. 18, 2010.

(51) Int. Cl. G06F 3/01

(52) U.S. Cl. 715/733

(57) ABSTRACT

Systems and methods for monitoring computer and/or software usage and enhancing functionality of target software applications are provided. In some aspects, the systems and methods may identify user activity with sufficient depth for meaningful analysis, even when the target application restricts access to, for example, its user-interface object model or event stream, without requiring code-level integration with the target application. In other aspects, the systems and methods may enable fast and convenient assignment of semantic meaning to user-interface elements to enable actionable usage reporting, among other things In further aspects, the systems and methods may allow convenient definition of a sequence of user-interface actions as a workflow, which may be analyzed in a variety of manners including, for example, monitoring and analyzing for user utilization and compliance. In other aspects, the systems and methods may be utilized where the target application restricts external access to user-interface object models.

### RELATED APPLICATIONS

The present application claims the benefit of co-pending U.S. Provisional Patent Application No. 61/338,343, filed Feb. 18, 2010, the entire contents of which are incorporated herein by reference.

### FIELD OF THE INVENTION

The present invention generally relates to software applications and, more particularly, to systems and methods for monitoring and enhancing software applications.

### BACKGROUND

Conventional software application monitoring, analysis, and enhancement tools have a variety of deficiencies. For example, conventional tools may have difficulty monitoring usability of a target software application that restricts external access to its user-interface object model. Also, for example, enhancement of a software application with conventional application-enhancement tools such as, for example, the macro engine embedded in Microsoft Excel, may require a significant software integration effort and/or be severely prevented or restricted in their enhancement capabilities by the technical architecture of the target software application.

Conventional manners of monitoring target software application usability require specific tasks to be completed and require specific data to be available in order to monitor software application usability. If such required data is not available, then the usability of the software application cannot be monitored and, therefore, cannot be analyzed. For example, some conventional software application monitoring tools may perform the following tasks to support usability analysis: 1) unobtrusively capture user-interface events and their attributes, such as identifying which user-interface control on the target application was activated by a user; 2) assign semantic meaning to each event, such as deducing that an event was the “clicking of the Submit Button on the Registration Form” rather than just the programmatic meaning “clicking of a button with control ID 67”; and 3) design and configure event data analytics and reports for those audiences who can drive remedies and improvement. In performing these tasks, current application monitoring tools may suffer from a variety of deficiencies.

With respect to the first task of capturing user-interface events, current capture tools are severely limited when these tools have only restricted programmatic access to the user-interface object model or event stream of the target software application. For example, when the target software application is an Adobe Flash or Microsoft Silverlight™ component embedded in a web page, the user-interface events generated from user interaction with the component do not indicate which user-interface controls within the component were activated. Similarly, for example, application event streams generated by mobile device applications also often lack requisite detail needed to adequately characterize user behavior. Another example occurs when a monitoring tool's usage capture component only has access to a virtualized version of a software application, such as that delivered through, for example, Citrix ICA™ or Windows RDP. In this case, the capture component only has access to a highly-limited set of user-interface attributes and events such as, for example, a graphical image of the software application window, window titles, window sizes and positions, window focus changes, mouse events, and keyboard events. For instance, when a user clicks tabs, drop-down lists, or radio buttons in a virtualized version of the target software application, events generated by these actions and captured by the monitoring tool cannot by themselves identify which user-interface controls in the target software application were clicked or selected.

Another difficulty with user-interface event capture occurs when monitoring a browser-based application. Conventional web analytics tools may capture user events that generate network traffic passing between a browser and a web server, such as HTTP GETs and POSTs. However, other user activities, such as moving the mouse or activating a window control that utilizes Javascript, do not trigger network traffic and, thereby, remain invisible to conventional web analytics tools.

With respect to the second task of assigning semantic meanings to user-interface events, using current monitoring tools for this purpose can be cumbersome. For example, conventional web analytics tools often require the tool user to examine HTML source code of the web application to associate a captured HTTP event with a particular user-interface control, such as an HTML form button. In addition, when an application monitoring tool captures screen video of user activity, a usability analyst (i.e., a person) must manually watch the video in order to attach semantic meaning to each captured user action. These time-consuming and error-prone manual methods for assigning semantic meaning to events severely restrict the practical sizes and extents of event data sets that can be accurately analyzed and interpreted. As a result, usability monitoring is often conducted on a limited set of user-interface events that do not reflect the entirety of how a target software application is used.

Finally, with respect to the third task of enabling the design and configuration of event data analytics and reports, current application monitoring tools lack easy means to define and track utilization of a sequence of user-interface elements that together make up an application workflow. For example, with respect to electronic heath records (EHR), the medication ordering process in an EHR software application may be composed of sequential “create new order”, “select medicine”, and “submit order” activities, each of which is comprised of a user activating a different user-interface element. Conventional monitoring tools often require error-prone procedures to program a tool to track the utilization or performance of such a workflow. For example, web analytics tools usually require the tool user to examine the target application's HTML source code in order to gather the HTTP URLs corresponding to the steps in a workflow. The lack of easy, quick, and error-resistant means of defining and attaching semantic meaning to a multi-step workflow is a key barrier to tracking important, complex patterns of application usage.

As indicated above, a deficiency of software application enhancement tools is that the tools may require significant software integration efforts and/or be prevented or restricted from making enhancements to the target software application, thereby preventing a user from enhancing the target software in a manner more preferred by the user. For example, the macro engine embedded in Microsoft Excel allows custom scripts to be written to automate common tasks within the application, effectively enhancing its functionality without requiring modifications to the source code of the Excel. However, it is a significant software development effort to build such an engine and integrate it into a target application. Or, the vendor of the target software application may prevent users from modifying or enhancing the application because the application is complicated to create, and a user generally does not have the required knowledge to perform enhancement or modification of the target software application at the programming or code level. A vendor may also restrict access to the application source code in order to protect its intellectual property.

These practical limitations of conventional application enhancement tools reduce the speed at which a target application could otherwise be enhanced, thereby leading to lower user satisfaction with the target software application. Commonly, target software applications are accessible by a wide variety of users on a number of different workstations, and users may use the target software application and the workstation for a wide variety of different purposes. Each user may have a different idea of an ideal configuration or operability of the target software application based on each user's personal preferences in addition to the tasks performed by each user. For example, a medical specialist using a generic EHR may only need to fill out several fields relevant to his/her practice scope, but must navigate through many screens filled with irrelevant fields to get to those fields. The number of medical specialists with this problem is often not large enough to justify an EHR vendor developing custom forms just for that specialty or for each user. Since such application enhancements are often expensive and time-consuming, they are not applied nearly enough to significantly improve the satisfaction of those users experiencing the greatest difficulties with the base application. “One-size-does-not-fit-all”, but unfortunately these users are too often forced to accept the limitations and inflexibilities of complex applications due to the aforementioned limitations of conventional application enhancement tools.

### SUMMARY

In one example, a system is provided for monitoring a software application.

In another example, a system is provided for enhancing a software application.

In yet another example, a system is provided for monitoring and enhancing a software application.

In still another example, a method is provided for monitoring a software application.

In a further example, a method is provided for enhancing a software application.

In yet a further example, a method is provided for monitoring and enhancing a software application.

In still a further example, systems and methods are provided to improve monitoring of software application usability. Such systems and methods may identify user activity with sufficient depth for meaningful analysis and data extraction, even when the target application restricts access to, for example, its user-interface object model or event stream, without requiring code-level integration with the target software application. In addition, such systems and methods may enable fast and easy assignment of semantic meaning to user-interface elements to enable actionable usage reporting. Further, such systems and methods may allow fast and easy definition of a sequence of user-interface actions as a workflow whose utilization and user compliance can be monitored and analyzed.

In another example, systems and methods are provided to more rapidly and inexpensively enhance and customize target software applications without depending upon the long and expensive development cycles needed to modify software code of the underlying target software application. In addition, systems and methods are needed that “layer on” a rapid enhancement and customization framework without requiring any software code modifications to the underlying target software application. For example, with respect to an EHR, a given version of an EHR software application may lack certain patient-safety checks and clinical decision support features in which a need for these features emerges only through real-world use of the EHR after the last EHR software development cycle is completed. Rather than having to wait for the next software release of the EHR target software application to incorporate these features, which may take many months or even years, or having to convince an application vendor that developing such features will be a profitable endeavor, a 3rd-party entity, such as an EHR implementor, may quickly and inexpensively add such features to the EHR target software application without depending upon the EHR vendor's application development cycle. Should such enhancement features prove valuable in practice, the EHR vendor may build such features into the next version of the product without having to risk resources on developing features with unproven financial value. The systems and methods may monitor usage of the target software application in real time and, upon designated user-interface events or conditions being met, may initiate one or more secondary application(s) to effectively enhance the functionality of the target software application. Secondary applications may run in the background or have their own user interface elements that are presented in conjunction with user interface elements of the target software application.

In yet another example, a method associated with a software application is provided and includes providing the software application, providing a first workstation including a first user interface, wherein the first workstation is adapted to access the target software application, providing a second workstation including a second user interface, wherein the second workstation is adapted to access the software application, displaying a first area of interest and a second area of interest associated with the software application on the first user interface of the first workstation, displaying the first area of interest and the second area of interest associated with the software application on the second user interface of the second workstation, defining the first area of interest as a first user-interface element with the second workstation, assigning a first element map to the first user-interface element with the second workstation, defining the second area of interest as a second user-interface element with the second workstation, and assigning a second element map to the second user-interface element with the second workstation, wherein the first element map is different than the second element map.

In still another example, a system associated with a software application is provided and includes the software application, a first workstation including a first user interface, wherein the first workstation is adapted to access the software application, and wherein a first area of interest and a second area of interest associated with the software application are displayable on the first user interface of the first workstation, and a second workstation including a second user interface, wherein the second workstation is adapted to access the software application and wherein the first area of interest and the second area of interest associated with the software application are displayable on the second user interface of the second workstation, wherein the second workstation is adapted to define the first area of interest as a first user-interface element and assign a first element map to the first user-interface element, and wherein the second workstation is adapted to define the second area of interest as a second user-interface element and assign a second element map to the second user-interface element, wherein the first element map is different than the second element map.

### BRIEF DESCRIPTION OF THE DRAWINGS

FIG. 1 is a schematic diagram of an exemplary system of the present invention;

FIG. 2 is a schematic diagram of an exemplary target workstation and various other exemplary elements of the system shown in FIG. 1;

FIG. 3 is a schematic diagram of an exemplary mapping workstation and various other exemplary elements of the system shown in FIG. 1;

FIG. 4 is an exemplary screen shot of the system shown in FIG. 1 illustrating a plurality of exemplary user-interface elements;

FIG. 5 is a schematic diagram of an exemplary analytics member and an exemplary platform database server of the system shown in FIG. 1;

FIG. 6 is a schematic diagram of an exemplary reporting member and the exemplary platform database server of the system shown in FIG. 1;

FIG. 7 is an exemplary report generated by the exemplary reporting member shown in FIG. 6, the exemplary report illustrates an exemplary workflow comprising a plurality of exemplary user actions;

FIG. 8 is a schematic diagram of an exemplary map validator workstation and various other exemplary elements of the system shown in FIG. 1;

FIG. 9 is an exemplary screen shot of the system shown in FIG. 1 illustrating a plurality of exemplary user-interface elements;

FIG. 10 is a plurality of exemplary screen shots of the system shown in FIG. 1 illustrating a plurality of exemplary user-interface elements and an exemplary map link;

FIG. 11 is an exemplary screen shot of the system shown in FIG. 1 illustrating an exemplary user-interface element and an exemplary mouse click on the exemplary user-interface element;

FIG. 12 is an exemplary screen shot of the system shown in FIG. 1 illustrating a plurality of exemplary user-interface elements and an exemplary captured image;

FIG. 13 is an exemplary screen shot of the system shown in FIG. 1 illustrating a first or base window and a second or pop-up window displayed over the first or base window, also shown are a user-interface element on the first window and a captured mouse click on the user-interface element on the first window to open the second window;

FIG. 14 is an exemplary screen shot of the system shown in FIG. 1 illustrating the same windows as FIG. 13, also shown are a user-interface element on the second window and a captured mouse click on the user-interface element on the second window to close the second window and return to the first window;

FIG. 15 is an exemplary screen shot of the system shown in FIG. 1 illustrating an exemplary captured image;

FIG. 16 is an exemplary workflow and analysis of the system shown in FIG. 1;

FIG. 17 is an exemplary report of the system shown in FIG. 1;

FIG. 18 is another exemplary report in chart form of the system shown in FIG. 1;

FIG. 19 is an exemplary screen shot of the system shown in FIG. 1, also shown are captured images of a plurality of user-interface elements;

FIG. 20 is a schematic diagram of an exemplary platform database server and various other exemplary elements of the system shown in FIG. 1; and

FIG. 21 is a schematic diagram of an exemplary element map of the system shown in FIG. 1.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION

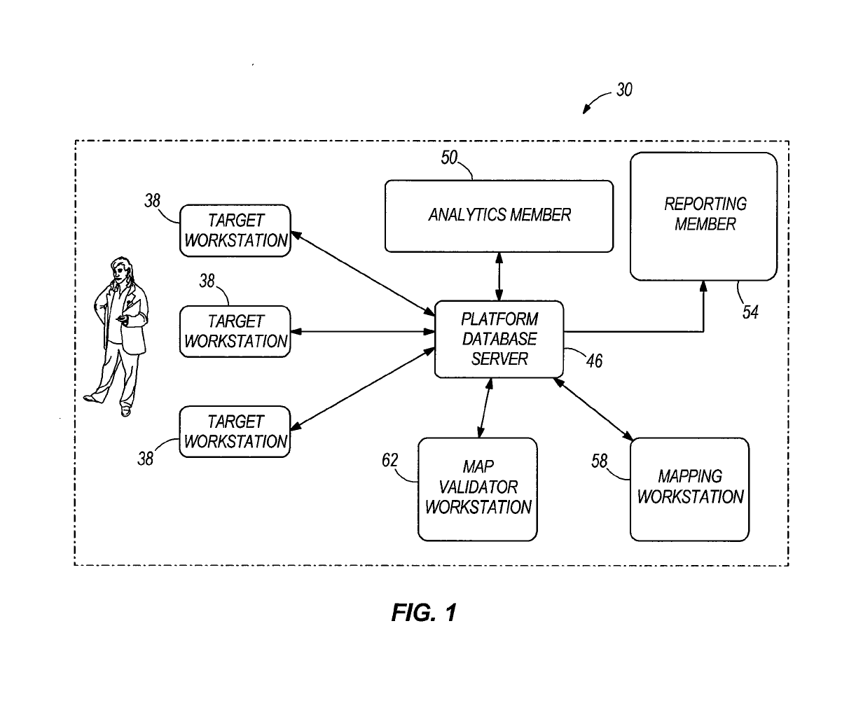

With reference to FIG. 1, an exemplary system 30 is illustrated for monitoring and enhancing software applications 34. The exemplary system 30 illustrated in FIG. 1 is only one of a wide variety of systems capable of monitoring and enhancing software applications 34 and all of such systems are intended to be within the spirit and scope of the present invention. The illustrated exemplary system 30 is not intended to be limiting in any way upon the present invention. In addition, a wide variety of methods for monitoring and/or enhancing software applications 34 are capable of being performed with the wide variety of systems of the present invention. Any method or methods described herein are not intended to be limiting upon the present invention. Rather, all of the wide variety of possible methods are intended to be within the spirit and scope of the present invention.

The systems 30 and methods of the present invention are capable of monitoring and enhancing a wide variety of types of software applications 34. Any description herein relating to a particular type of software application is not intended to be limiting upon the present invention. Rather, description relating to any particular type of software application is for exemplary purposes only and the present invention is intended to cooperate with any type of software application.

The exemplary systems 30 and methods disclosed herein will be described in connection with a software application 34 associated with electronic healthcare records (EHRs) in the healthcare field and such a software application will be referred to as a target software application 34. Description relating to the use of this EHR target software application 34 is for exemplary purposes only and is not intended to be limiting upon the present invention. The systems 30 and methods of the present invention may be used with any type of software application and be within the intended spirit and scope of the present invention.

With continued reference to FIG. 1, the exemplary system 30 may include a plurality of target workstations or servers (such as virtualization servers) 38, a target software application 34, a software agent 42, a platform database server 46, an analytics member 50, a reporting member 54, a mapping workstation 58, and a map validator workstation 62.

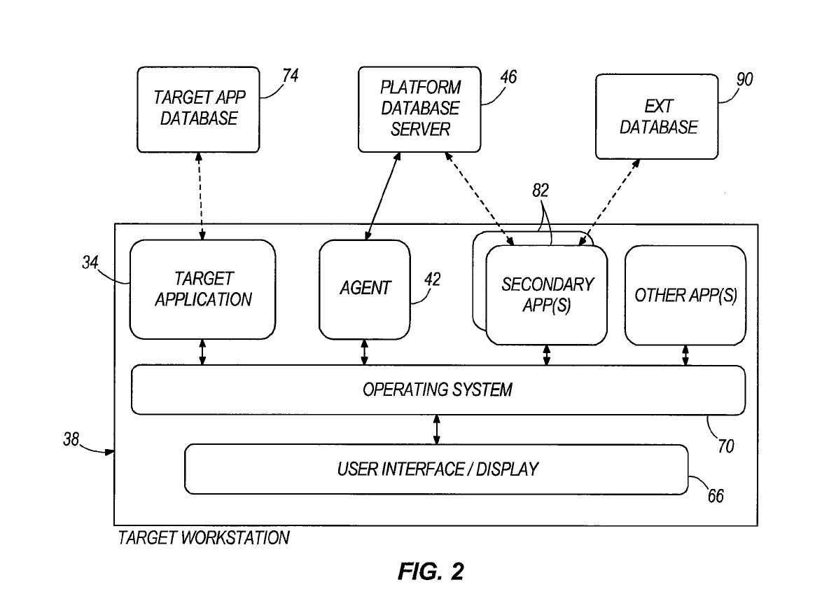

With particular reference to FIGS. 1 and 2, some exemplary embodiments of target workstations 38 may comprise a personal computer, laptop, or other computing device including, for example, a user interface device or display 66, an operating system 70, among other elements described in more detail below. In some exemplary embodiments, the operating system 70 may include both software and hardware elements such as, for example, operation software (e.g., Microsoft Windows, etc), a processor, memory, or any other software or hardware necessary to support operation of the target workstation 38. The target software application 34 may be stored on the target workstation 38 in the memory, or may be stored on another storage medium separate from the target workstation 38 such as, for example, a target application database 74. The target workstations 38 may access the target software application 34 to run the target software as needed.

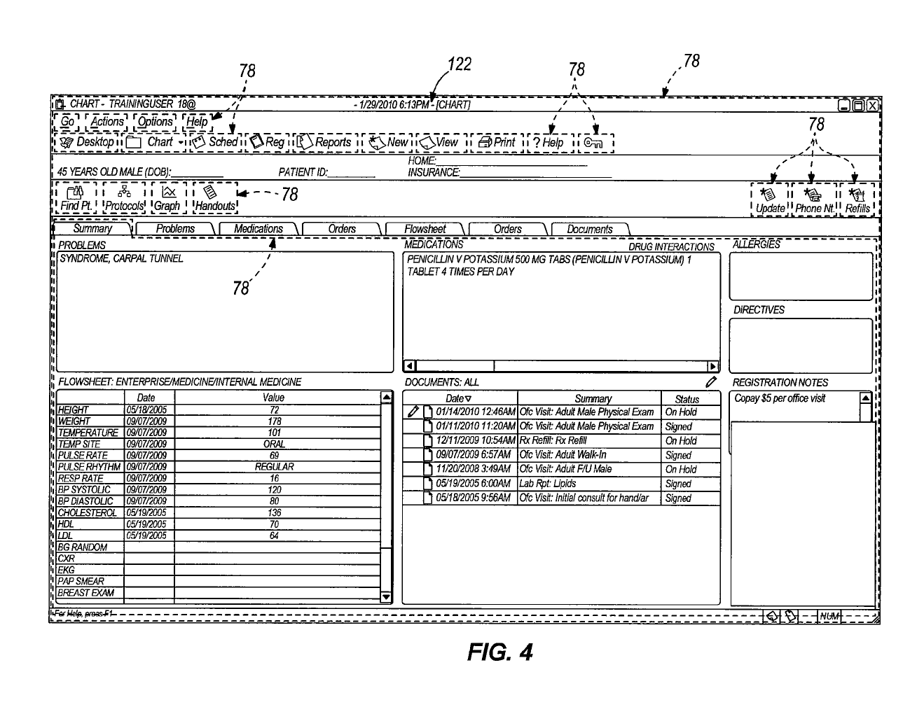

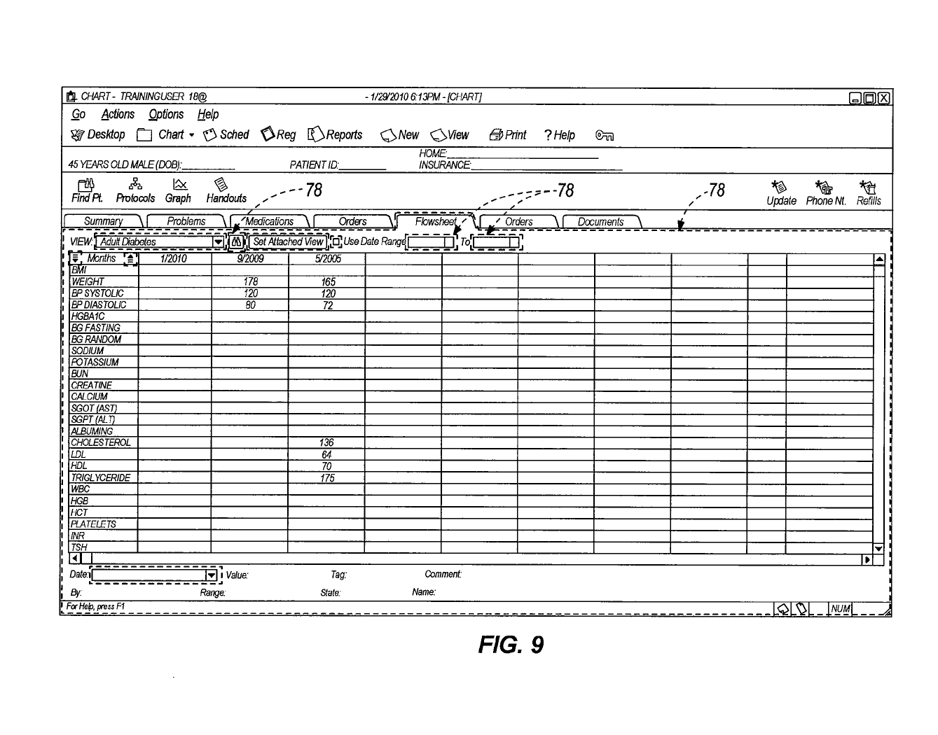

With continued reference to FIGS. 1 and 2 and in some exemplary embodiments, software agents 42 may be deployed on the target workstations 38 having access to the target software application 34. The agents 42 capture target application user-interface events and upload event data associated with the user-interface events to the platform database server 46. Exemplary user-interface events may include, but are not limited to, user-interface-control identifiers, window titles, window sizes and positions, types of mouse events, types of keyboard events, real-time captured images of window regions associated with the user-interface events, etc. Agents 42 may also be configured to harvest or extract, store, and upload data values extracted directly from user-interface elements 78 (see FIGS. 4 and 9) such as, for example, text boxes, labels, list boxes, radio buttons, etc. Agents 42 may be able to harvest or extract such data in a variety of manners including, for example, harvesting or extracting such data through interrogating the user-interface object model of the target software application 34, through image capture combined with optical character recognition (OCR), or any other manner. As an example with respect to an EHR related target software application 34, an agent 42 may extract and store a physician's name from a label on a form in an EHR, collect a set of field values from a list box in order to capture all the choices with which a user is presented, etc. In some embodiments, the agent 42 may then apply rules to analyze such extracted data in real-time for the purpose of carrying out actions beyond just monitoring usage such as enhancing the functionality of the target application 34 (described in more detail below).

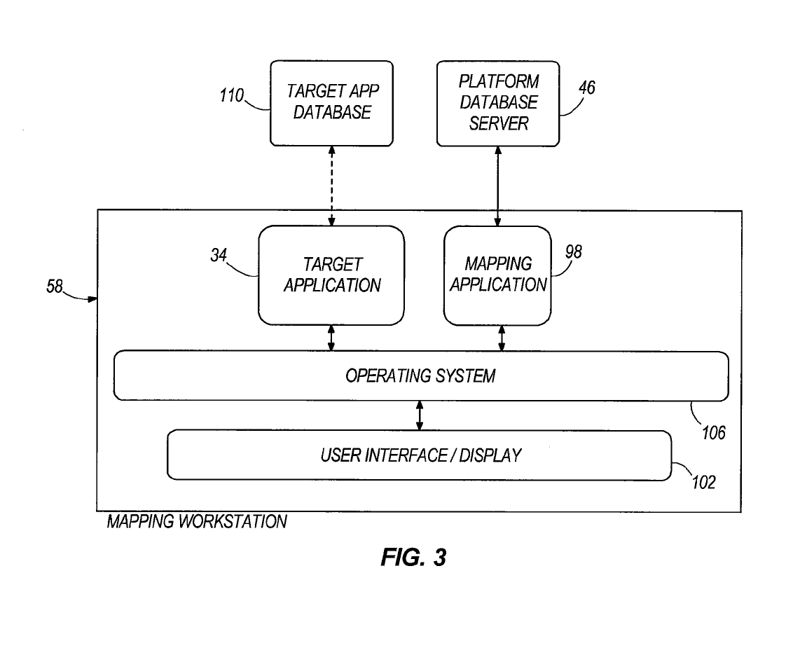

With continued reference to FIGS. 1 and 2, the agent 42 may also be programmed by a mapping application 98 (see FIG. 3) of the mapping workstation 58 (described in more detail below) to launch one or more secondary applications 82 upon occurrence of a particular set of conditions in the target software application 34. In some instances, secondary applications 82 may be referred to as “helper applications” since such applications are commonly used to assist or help users while using the target software application 34. Such “helper applications” will be referred to herein as secondary applications 82. The use of the term “secondary” is merely used as nomenclature to differentiate the secondary application(s) from other applications described herein such as, for example, the target software application 34, and such use of the term “secondary” does not imply any special meaning to the applications with which the term “secondary” is used.

The secondary applications 82 may have a variety of functions and be utilized in a variety of manners, all of which are intended to be within the spirit and scope of the present invention. The following exemplary embodiments of functionality and utilization of the secondary applications 82 are presented for exemplary purposes only and are not intended to be limiting upon the present invention. In some exemplary embodiments, a secondary application 82 may launch if a user is in danger of incorrectly using the target software application 34, to assist a user with auto-filling commonly used field boxes, or a variety of other reasons. The agent 42 may, in real-time, apply decision rules (e.g., configured through the mapping application 98—see FIG. 3) to decide whether to launch a secondary application 82 upon occurrence of a particular user-interface event. Data for establishing rules for launching secondary applications 82 may originate from many sources and in many manners. For example, data inputs for this rule processing may originate from contextual data retrieved from user-interface elements 78 or events on the current application window, data collected and stored from past elements 78 or events in the current application session, data retrieved from the platform database server 46, and/or external data sources, etc. With this access to and use of a variety of different data sources, agents 42 are able to leverage a wide-range of contextual data sources to decide when to trigger a secondary application 82 so that the agents 42 launch the secondary application(s) 82 at correct times and correct places within the target software application 34. This ultimately enhances the functionality of the target software application 34.

In other exemplary embodiments, a secondary application 82 may be launched as a pop-up user-interface element displayed to the side of or over a current user-interface element displayed in the user interface 66. An example of this embodiment is described hereinafter and such an example relates to EHRs. More particularly, a target software application 34 may display a medication order form associated with an EHR in user-interface 66 and the agent 42 may check whether the medicine just selected by the user on the form is appropriate for the patient's age. The age of the patient may be extracted from an “age” label control and the agent 42 may apply the rule, which is programmed through the mapping application 98, to make this determination. If the rule is violated (e.g., a non-age appropriate medication is selected), then the agent 42 may launch an alert box 78 in the user-interface 66 to the side or over the user-interface form 78 displayed in the user-interface 66 informing the user of the problem before the order is submitted. This may inhibit medication errors from occurring.

In further exemplary embodiments, secondary applications 82 may run in the background and/or upload data to the platform database server 46 or to other external databases 90 (see FIG. 2). An example of this embodiment is described hereinafter and such an example relates to EHRs. More particularly, with reference to the previous example, the agent 42 may also launch a second secondary application 82, which captures and uploads a screen video of the display of the user-interface. The screen video captures in fine detail what the user does after the medication-error alert (i.e., alert box associated with the first secondary application in the previous paragraph) is presented. Another example of this exemplary embodiment also relating to EHRs pertains to a third secondary application 82 that harvests data values from an EHR immunization-record form 78 and uploads the data to an external database 90 such as, for example, an external immunization registry. This secondary application 82 may bypass conventional means of integrating an EHR with an immunization registry, which may be expensive or take a long time to implement.

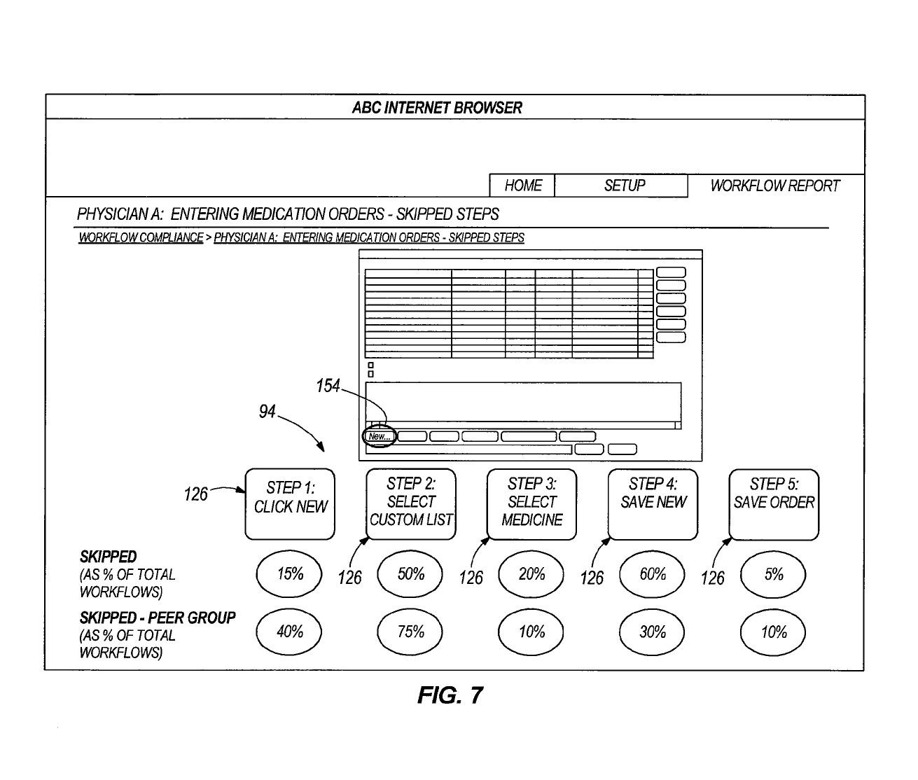

In still other exemplary embodiments, secondary applications 82 may directly request the user to input information not captured by the target software application 34 itself. For example, upon a user completing a target software application workflow 94 (e.g., see FIG. 7) and clicking a “Submit” button 78, the agent 42 may launch a form box or other user-interface element 78 in the user-interface over another user-interface element 78 requesting the user to rate the user experience. The agent 42 then uploads inputted data to a database. The agent 42 may even intercept a user event such as, for example, a button click before the event is passed by the application workstation's operating system 70 to the target software application 34. In conjunction with intercepting the event, the agent 42 may launch a secondary application 82 that gives the user an option to cancel the event or allow the event to be passed onto the target software application 34. This exemplary feature may inhibit potential user mistakes. For example, if a user clicks a “Submit” button 78 on an EHR medication order form 78 on which the agent 42 has detected selection of an incorrect medication, then the agent 42 may intercept the “Submit” button event and present the user with a dialog box 78 highlighting the error and enabling the user to cancel the event before the target software application 34 receives it.

In still further exemplary embodiments, a secondary application 82 may reduce a number of clicks or keystrokes necessary for a user to execute or carryout a workflow 94. For example, upon a target software application form 78 being opened in the user-interface, the agent 42 may display a dialog box 78 asking whether the user would like a secondary application 82, which in this example may be a software robot, to automatically populate fields with certain values before the form 78 is displayed in the user-interface to the user for further editing. The secondary application 82 may also automatically navigate and populate a series of forms 78 displayed in the user-interface by leveraging the navigational maps of the target software application 34 defined using the mapping application 98 (see discussion below of the mapping application 98 and mapping workstation 58).

The ability for an agent 42 to launch one or more secondary applications 82 at particular points of usage of a target software application 34 enhances functionality of the target software application 34 without having to modify the software code of the target software application 34 itself. This ability may accelerate delivery of new functionality to the market to benefit end users and alleviates the burden realized by vendors of target software applications 34 to customize their application software code for a variety of customers, each of which may have widely varying requirements and preferences.

With continued reference to FIG. 1 and additional reference to FIG. 3, the exemplary system also includes a mapping workstation 58. The mapping workstation 58 may be comprised of a variety of different elements such as, for example, hardware and software, all of which are intended to be within the spirit and scope of the present invention. The mapping workstation 58 described and illustrated herein is presented for exemplary purposes and is not intended to be limiting upon the present invention. The exemplary mapping workstation 58 may comprise a mapping application 98 (e.g., software application) enabling configuration and programming of the agents 42 and analytics member 50. In some exemplary embodiments, the mapping workstation 58 may comprise a personal computer, laptop, or other computing device including, for example, a user-interface or display 102, an operating system 106 including a processor and data storage or memory, the target application 34, and the mapping application 98. The target software application 34 may be stored on the mapping workstation 58 in memory or may be stored on an external target application storage medium or database 110 separate from the mapping workstation 58. The external target application database illustrated in FIG. 3 may be the same or different from the external target application database 74 shown in FIG. 2 in connection with the target workstation 38. The mapping workstation 58 may access the mapping application software 98 to run the mapping application software 98 as needed. In some exemplary embodiments, through a graphical “drag-and-drop” tool displayed on the user-interface 102 of the mapping workstation 58, the mapping application software 98 enables fast and easy identification of user-interface elements 78 of the target software application 34 that are displayable on the target workstations 38, assignment of semantic meaning to these user-interface elements 78, definition of conditions and rules under which agents 42 should launch designated secondary applications 82, definition of conditions and rules under which agents 42 should extract certain data values from user-interface elements 78 for use by aforementioned secondary application launch conditions and rules or by the secondary applications 82 themselves, and configuration of algorithms that the analytics member 50 should apply to captured event data (e.g. defining and monitoring sequential workflows 94). In order to enable the mapping application 98 to capture attributes of user-interface elements 78 of the target software application 34, the mapping workstation user runs the mapping application 98 in conjunction with accessing the target software application 34 on the mapping workstation 58.

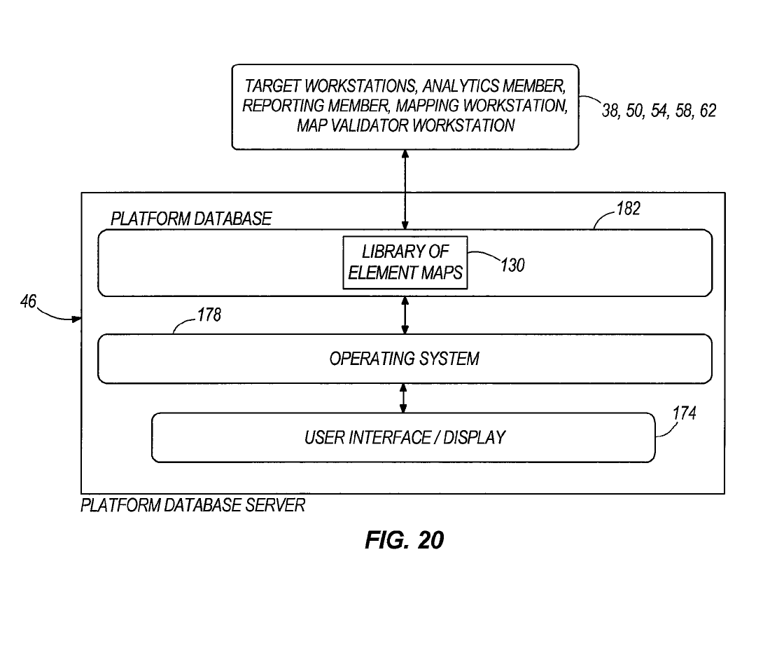

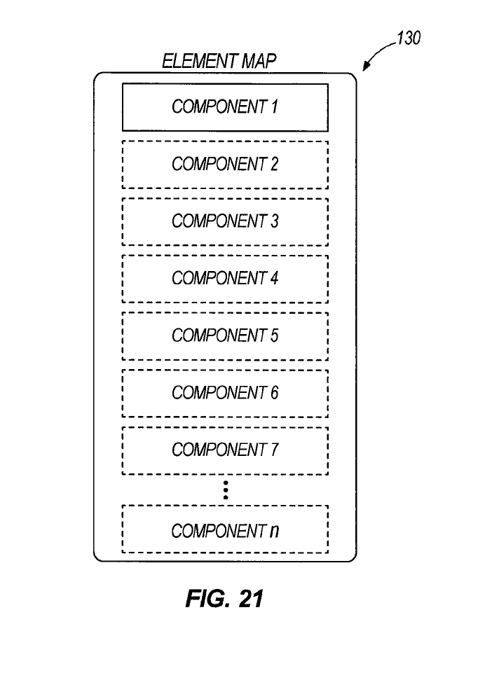

A mapping workstation user opens the target software application 34 on the mapping workstation 58, then navigates the target software application 34 to an application window of interest. Next, the mapping workstation user uses the mapping application 98 to capture attributes of user-interface elements 78 of interest displayed in the target application window. Examples of user-interface elements 78 include, but are not limited to, portions of application windows, list boxes, buttons, text boxes, tab controls, labels, entire windows, etc. A user-interface element 78 may also contain other user-interface elements 78, thereby representing a parent-child relationship between user-interface elements 78. An example of a parent-child relationship between user-interface elements may include a form user-interface element displayed in the application window as a parent user-interface element and the displayed form may include buttons, list boxes, tab controls, and/or text boxes, all of which are child user-interface elements of the form user-interface element because the child user-interface elements are contained within the parent user-interface element. Attributes of a user-interface element 78 captured by the mapping application 98 are stored in a data structure called an element map 130 (see FIGS. 20 and 21). A mapped user-interface element 78 is a user-interface element 78 for which the mapping application 98 has been used to create an element map 130. A child element map 130 is an element map 130 for a child user-interface element 78 and a parent element map 130 is an element map 130 for a parent user-interface element 78. Similarly, a child element map 130 is also a sibling element map 130 to other child element maps 130 sharing the same parent element map 130.

An element map 130 stores attributes of a user-interface element 78 defined directly by a user of the mapping application 98 or according to algorithms or processes executed by the mapping application 98. An element map may contain any quantity of attributes and data relating to a user-interface element 78. In some exemplary embodiments, each element map may contain, at minimum, a primary key that: (i) uniquely identifies the element map from all other element maps stored in the platform database server 46; and (ii) enables the retrieval of an element map of a user-interface element 78 utilizing attributes of one or more user-interface event(s) action upon that user-interface element 78, a parent user-interface element 78, and/or another user-interface element 78 whose activation results in navigating to the user-interface element in question. As an example of (ii), if a target application user clicks a button 78 displayed on an application form, then the attributes of one or more user-interface event(s) generated by that button click may be used to construct a primary key value that can then be used by the agent 42 or analytics member 50 to retrieve that button's element map from the platform database server 46.

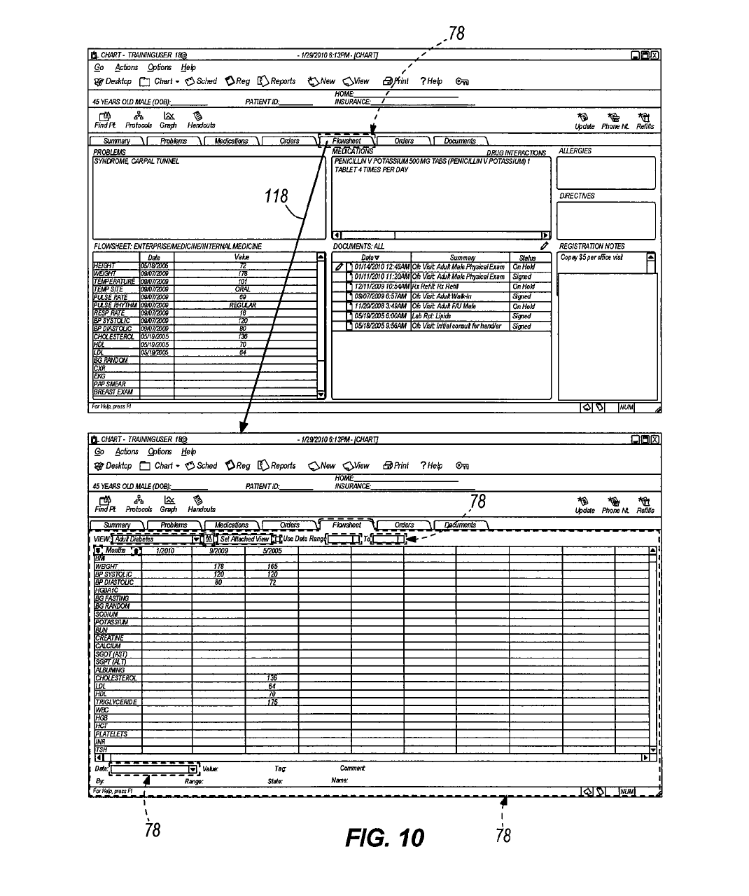

In other exemplary embodiments and with reference to FIG. 21, each element map 130 may include a primary key (i.e., element map component 1) and additionally include: selected attributes of the user-interface element 78 (i.e., element map component 2) such as, for example, the element's 78 pixel size, pixel location on a parent user-interface element 78 containing the element 78 in question, the user-interface element's 78 unique programmatic identification number, the type of user-interface element 78 (e.g., text box, list box, button), and/or attributes of the parent user-interface element 78; the user-interface element's 78 assigned semantic meaning (i.e., element map component 3) such as, for example, the mapping workstation user assigning a button 78 the semantic meaning “Submit Button on the Registration Form” by using the mapping application 98; rules (i.e., element map component 4) defining the conditions under which agents 42 should extract and store user-input values from the user-interface element 78, its parent user-interface element 78, and/or child user-interface elements, and definitions of the semantic meanings of these extracted values; rules (i.e., element map component 5) defining conditions associated with user-interface events generated by the user-interface element 78 under which agents 42 should launch one or more designated secondary applications 82, whereby the rules and/or the secondary applications 82 themselves may use as inputs the aforementioned extracted user-input values; references to child element maps associated with child user-interface elements 78 (i.e., element map component 6); and a set of map links 118 (i.e., element map component 7) (see, for example, FIG. 10), each of which defines a navigational relationship between the user-interface element 78 and another user-interface element 78 displayed upon the first user-interface element 78 being activated by a particular user-interface event such as, for example, a left mouse click on a button which is the first user-interface element 78.

It should be understood that an element map may include any number of the above-identified components, any combination of the above-identified elements, or any other components and be within the intended spirit and scope of the present invention. The exemplary components identified above are only exemplary components and are not intended to be limiting upon the present invention.

With respect to component (1) of each element map, the primary key may be generated by an algorithm utilizing attributes of the user-interface element 78, attributes of the element's parent user-interface element 78, attributes of the element's child user-interface elements 78, and/or a numeric value assigned by a mapping workstation user or by a mapping application number generator. In instances where an algorithm generates the primary key, the algorithm may vary based on the type of target software application 34 with which the mapping application 98 is associated. For example, in one exemplary embodiment, the primary key of the element map for a form user-interface element 78 may be derived from a combination of the form's displayed title 122, pixel width (i.e., the entire width of the target application form), and pixel height (i.e., the entire height of the target application form). In another exemplary embodiment, the primary key may be a unique programmatic ID of the form user-interface element 78 deduced from the mapping application 98 interrogating the target application form's user-interface object model. Among all element maps for a target software application 34, each element map may be uniquely and universally identifiable through its own primary key, which may be derived from a combination of attributes of the user-interface element 78 and attributes of its parent and/or child user-interface elements 78.

The following is a more detailed example of a primary key definition and how the primary key may be used to retrieve an element map. Referring now to FIG. 4, an exemplary target application form displayable on a user interface 102 of the mapping workstation 58 is illustrated. This illustrated target application form is presented for exemplary purposes only and is not intended to be limiting upon the present invention. Many different types of target software applications are possible and such different types of target software applications are capable of displaying many different types of windows and pages, all of which are intended to be within the spirit and scope of the present invention. It should be understood that the dashed borders illustrated in the user-interface 102 of the mapping workstation 58 are visible, but will not be visible in the user-interface 66 of the target workstation 38. The dashed borders are created by a user of the mapping workstation 58 to define the borders of each user-interface element 78 of the target software application 34. The illustrated dashed borders surround only a portion of the many possible user-interface elements displayed on the user interface 102 of the mapping workstation 58. For example, only the “Summary” user-interface element is surrounded by a dashed border in FIG. 4 wherein numerous other user-interface elements exist such as, for example, “Problems”, “Medications”, etc., user-interface elements 78.

In the illustrated exemplary embodiment of FIG. 4, the target software application 34 relates to EHRs and the displayed EHR form is generated and displayed by the EHR application. The element map for the illustrated form user-interface element 78, which is identified by the largest dashed border, includes a primary key composed of: (a) the target application form title 122 or portion thereof filtered using a textual filtering technology (such as, for example, regular expressions), such as “CHART”; (b) the pixel width of the entire form; (c) the pixel height of the entire form; and (d) captured images of selected child user-interface elements 78 such as, for example, those surrounded by dashed border in FIG. 4 and contained within the form. In this example, the mapping application 98 has previously captured an image of each child user-interface element 78 (e.g., “Summary” tab, “Handouts” button, etc.) and stored the image as an attribute in the corresponding child element map referenced by element map component (6) of the form user-interface element 78. The captured image of each child user-interface element 78 may be a composite of more than one image, each of which may be rectangular or otherwise polygonal in shape. For example, in FIG. 4, the captured image of the “Summary” tab may comprise a first rectangle image of the upward extended portion of the tab and a second rectangle image of the remainder of the tab below the upward extended portion. Since the parent element map, which is the element map for the form user-interface element 78 in this example, contains references to each child element map (e.g., element map component 6), the parent element map can use the mapping application's captured images of selected child user-interface elements 78, or portions thereof, as primary key component (d) above. Together, components (a), (b), (c), and (d) of the primary key define a unique identifier for the element map of the form user-interface element 78 displayed in FIG. 4.

To illustrate how a primary key may be used to retrieve an element map for a particular user-interface element, imagine that a user clicks on a button (i.e., user-interface element) within the target application which results in the opening and display of the form user-interface element occupying the entire target application window shown in FIG. 4. The agent 42 captures attributes of the “open window” user-interface event, deriving the primary key components (a), (b), and (c). While the form user-interface element 78 is still open, the agent 42 searches the platform database server 46 for all primary keys matching components (a), (b) and (c) to derive a reduced list of element maps among which one element map is for the form user-interface element displayed in FIG. 4. In order to find the correct element map within this reduced list using primary key component (d), the agent 42 queries each element map's child element maps for the pixel locations and sizes of the captured images of the child user-interface elements 78 contained within the user-interface element corresponding to that element map within the reduced list. Then, while the form user-interface element 78 illustrated in FIG. 4 is still open and for each element map in the reduced list, the agent 42 captures images of regions of the form user-interface element 78 corresponding to the aforementioned pixel locations and sizes of the aforementioned child user-interface elements referenced by each element map in the reduced list. Finally, for each element map in the reduced list, the agent 42 performs an image comparison between the real-time captured images of the form user-interface element 78 and the images stored in the child element maps to determine whether that element map in the reduced list has a matching primary key component (d). If so, then the agent 42 records in the “open window” user-interface event record, which is uploaded to the platform database server, a unique numerical identifier for the matching element map's primary key corresponding to the form user-interface element. When the analytics member 50 subsequently processes that user-interface event record, the analytics member 50 will use the unique numerical identifier to retrieve the correct element map corresponding to the form user-interface element and to use for further analyzing the event or subsequent events whose processing requires that element map. It should be understood that the components of the primary key and the process for identifying the correct element map corresponding to a user-interface event may be different to accommodate the needs and requirements of other types of target software applications or target software application deployment scenarios.

Regarding component (4) of each element map, the user of the mapping workstation 58, through utilizing the graphical user interface 102 of the mapping workstation 58, may direct the agent 42 to extract selected input data values contained within the user-interface elements, its parent user-interface element, and/or child user-interface elements. These data values may be used by the rules contained in component (5) of the same or a different element map and/or by the secondary applications 82 launched according to component (5) of the same or a different element map. The agent may store in its own local database or on the platform database server any such extracted input data values for any period of time as needed by the agent 42, secondary applications 82, or other components of the present invention. For example, a rule associated with component (4) may include configuring the agent 42 to capture a user-interface element's input data value such as, for example, a user-selected value of a list box, whenever a user of the target software application 34 clicks on that list box. Such an input data value could be stored by the agent 42 in its local database for subsequent use during the same target application user session or subsequent user session. Also, for example, a rule associated with component (4) of an application form's element map may include configuring the agent 42 to extract and store all possible input data values listed in a child list box whenever the user navigates to that application form. Component (4) also stores any semantic meanings of such user-input values assigned by a user using the mapping application. For example, if a list box on an EHR medication-ordering window lists as input values choices “Brand X Aspirin” and “Generic Aspirin”, then the mapping workstation user may assign the semantic meaning “brand name drug” to the input value “Brand X “Aspirin” and “generic drug” to the input value “Generic Aspirin”.

Regarding component (5) of each element map, the user of the mapping workstation 58 may designate that certain secondary applications 82, either installed on every target software application workstation 38 or on a remote machine/workstation, be invoked when certain triggering conditions in the target software application 34 are met such as, for example, if a particular user-interface event occurs, if particular data fields in the user session have certain values, etc. The mapping application 98 enables definition of algorithms and data sources, including databases in which the agent 42 has stored the aforementioned extracted data values according to component (4) of the element maps, utilized by agents 42 to determine triggering conditions during real-time usage of the target software application 34 in order to launch secondary applications 82.

Regarding component (7) of each element map, the user of the mapping workstation 58 may designate one or more user-interface events activating the user-interface element, each of which results in the display of another mapped user-interface element. For example, if the user-interface element is a button, then component (7) of its element map would contain a reference to the element map of, say, a form user-interface element and the latter's pixel height and width and location on the display relative to that of the button. Another example assumes that the first user-interface element is the form user-interface element occupying the entire target application window in FIG. 4. Then, component (7) of the corresponding element map may contain a navigational rule specifying that a left-button mouse click in the region surrounding the upward extended portion of the “Flowsheet” tab results in the display of the remainder of the “Flowsheet” tab positioned below the upward extended portion (shown in FIG. 9) and referencing the “Flowsheet” tab's element map, which, as a child element map of the form user-interface element's element map, is also referenced in component (6) of the element map of the form user-interface element. A map link may also define a navigation from a keyboard stroke or stroke combination to a mapped user-interface element. For example, a user may depress the “control” keyboard button along with the “O” keyboard button to open an “Open File” form.

In order to properly interpret subsequent mouse user-interface events occurring in the portion of the “Flowsheet” tab below the upward extended portion, it may be necessary to know the coordinates of such mouse user-interface events relative to the coordinate system of the form user-interface element occupying the entire target application window. The following is one possible mechanism through which such coordinates may be derived from information contained in the relevant element maps. Continuing the previous example and with reference to FIG. 9, the “Flowsheet” tab's element map component (6) contains references to child element maps, such as that of the “Set Attached View” button user-interface element. In turn, the “Set Attached View” button's element map may have as an attribute, stored in its element map component (2), the button's pixel location relative to the upper-left corner of the main body of the “Flowsheet” tab (the parent user-interface element of the “Set Attached View” button). Similarly, the pixel location of the upper-left corner of the main body of the “Flowsheet” tab relative to the form user-interface element's upper-left corner may be stored in the “Flowsheet” tab's element component (2) as an attribute. By adding the two aforementioned pixel locations stored in parent-child element maps, the “Set Attached View” button's pixel location relative to its grandparent form user-interface element may then be calculated.

In addition to enabling definition of element maps, a user of the mapping workstation 58 may be able to use the mapping application 98 to rapidly and easily configure algorithms utilized by the analytics member 50 to analyze the user- interface event data gathered by the agents 42. For example, the analytics member 50 may be directed to calculate an average amount of time users spend viewing a particular target application user-interface element such as an application window, displayed on the user interface 66, or compare numbers of times different target workstation 38 users click on a particular displayed button 78. More particularly, the user of the mapping workstation 58 may define a workflow 94 (e.g., see FIG. 7) composed of a sequence of user actions 126(e.g., see FIG. 7) in the target software application 34, and the analytics member 50 may analyze such user actions 126 to derive metrics of usage or workflow compliance. Each user action 126 corresponds to activation of a user-interface element 78, expressed as a combination of a user-interface element 78 and a user-generated user-interface event that acts upon or occurs in the context of that element. For example, a user action may be a left mouse click event action upon a particular button on a form. Another user action may be a certain key-press performed while a particular target application form is at the forefront of the user interface 66.

The mapping application 98 then links together multiple user actions 126 to define a workflow 94. For example, in the exemplary field of healthcare, a medication ordering process in an EHR application 34 may be comprised of a plurality of sequential user actions 126 with assigned semantic meanings such as, for instance, “create new order”, “select medicine”, and “submit order”. Each of these exemplary user actions 126 may be comprised of a user-interface event associated with a different mapped user-interface element 78. For example, the “create new order” user action may be composed of a left-mouse click (user-interface event) performed on a button 78 (mapped user-interface element) located on a target application form displayed on the user-interface. The analytics member 50 subsequently analyzes data captured by the agent 42 to deduce an actual level of compliance with the workflow 94 such as, for example, how many times a user action was skipped, incorrectly performed, or performed out of order in the course of completing the workflow 94. The mapping application 98 may also enable programming of the map validator application 170 (described in more detail below).

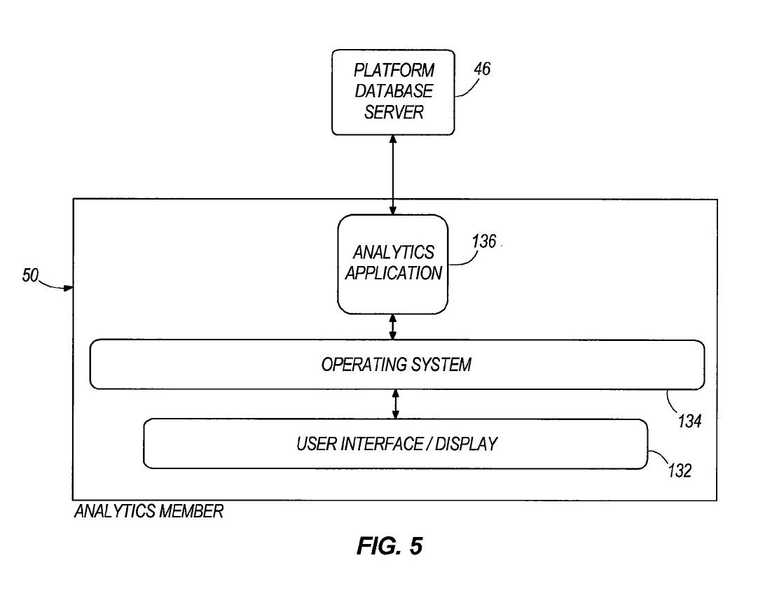

With further reference to FIG. 1 and additional reference to FIG. 5, the exemplary system 30 includes an exemplary analytics member 50 and the exemplary analytics member 50 may include, for example, a user interface or display 132, an operating system 134, and an analytics application 136 (i.e., software). In some exemplary embodiments, the operating system 134 may include both software and hardware elements such as, for example, operation software (e.g., Microsoft Windows, etc), a processor, memory, or any other software or hardware necessary to support operation of the analytics member 50. In some exemplary embodiments, the analytics 50 may include a software component such as, for example, the analytics application 136 that searches user-interface event data stored in the platform database server 46 for instances of particular user actions such as, for example, mouse clicks on a particular button on a particular target application form. The analytics member 50 may analyze, in other ways, the data captured by agents 42 and secondary applications 82 and stored in the platform database server 46. For example, with reference to a medication-order application window in an EHR, the analytics member 50 may analyze user-input data values extracted by agents 42 such as, for example, medication names selected by the EHR application user to determine if any banned medications were ever selected and, if so, by which EHR user(s). The analytics member 50 may then store such analysis results back in the platform database server 46 for later retrieval by a reporting member 54, agents 42, secondary applications 82, or other platform components as needed.

The analytics member 50 is capable of performing a wide variety of operations, tasks, and analyses, and any such operations, tasks, and analyses are intended to be within the intended spirit and scope of the present invention. Exemplary operations, tasks, and/or analyses of the analytics member 50 are described herein and are not intended to be limiting, but, rather, are intended to assist with an understanding of the analytics member 50.

In some exemplary embodiments, the analytics member 50 uses the element maps' primary keys to identify which element map should be used to retrieve the semantic meaning associated with a given user-interface event or element 78. For example, if a user action consists of a left mouse click occurring on a “Registration Form”, then the attributes of the mouse click user-interface event could be used by the analytics member 50 to construct an assumed primary key for retrieving the element map for the target application form upon which the mouse click occurred. In order to know which child user-interface element 78 on that target application form was clicked, the analytics member 50 may compare the pixel location of the mouse click to the pixel locations and sizes of each child user-interface element 78 as stored in the child element maps (element map component 6) of that element map. The analytics member 50 may then retrieve the semantic meaning of the clicked child user-interface element 78 from the matching child element map, thereby deriving a semantic meaning of the user action such as “Left Mouse click on Submit Button on Registration Form”, and store that semantic meaning to the user-interface event record in the platform database server 46.

In other exemplary embodiments, the analytics member 50 may be capable of generating insights into target software application usage. To achieve such insights, the analytics member 50 may analyze user-interface event data, user-input data extracted from user-interface elements, data uploaded by secondary applications 82 to the platform database server 46, etc. For example, with reference to the button click in the “Registration Form” example in the previous paragraph, the analytics member 50 may sum all such button clicks to generate a report on the number of times that button has been clicked in a particular period of time on various target workstations 38. Taking this example further, the analytics member 50 may determine how often that button is clicked correlated with the value of data shown in another user-interface element 78 such as, for example, a form label field, on the exemplary “Registration Form” at the time of the button click. An exemplary label field may be an “EHR User” label field, whose value may be extracted and stored in the platform database server by the agent 42 and which may then be used to identify differences in button-click frequency among various users of the target software application 34. As a further extension of this example, an agent 42 on the target workstation 38 may launch a secondary application 82 upon clicking of a button 78 and such secondary application 82 may enable the user to either cancel the click or proceed (i.e., a double check to ensure the user intended to click the target application button). After a user selects to cancel or proceed, the agent 42 may store the user's choice in the platform database server 46 and the analytics member 50 may also correlate the cancel/proceed choice with values of the “EHR User” field to determine differences in behavior among users of the target application workstations 38. In addition, as described previously, the analytics member 50 may measure user compliance with sequential workflows defined with the mapping application 98 such as, for example, how many times a user action was skipped or performed out of order in the course of completing the workflow 94. FIG. 7 shows an example report that may be generated by the reporting member 54 based upon such a compliance measurement performed by the analytics member 50.

In further exemplary embodiments, the analytics member 50 may store, in the platform database server 46, identified attributes and metrics of usage associated with usability of the target software application 34, quality of workflow 94 design as reflected by observed workflow user behavior, user compliance with best-practice workflows 94, etc. Furthermore, agents 42 may retrieve such attributes and metrics of usage from the platform database server 46 to determine, in real-time, whether to launch secondary applications 82 at designated points during particular target application users' use of the target software application 34.

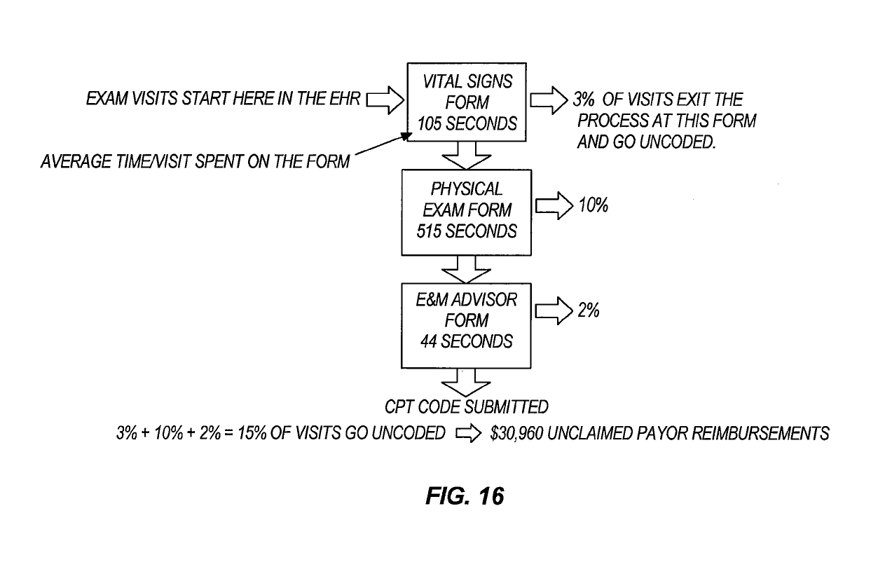

With reference to FIG. 16, an exemplary analysis such as, for example, a funnel analysis is illustrated and may be executed by the analytics member 50 and displayed by the reporting member 54. In context of an EHR target software application, a target workstation 38 user may navigate through a series of target application forms during a patient visit in order to submit a medical billing code, which results in a billing event and reimbursement by an insurance payer. However, as seen in FIG. 16, a percentage of visits abandon the process at each target application form, resulting in visits that go un-coded, thereby causing a loss in revenue for the organization utilizing the target software application. Analysis by the analytics member 50 of the navigational patterns in the event data may identify an abandonment rate at each target application form, as well as the average time per visit spent on each target application form. In this example, the 2nd target application form, or Physical Exam Form, in the workflow has the highest abandonment rate and average time per visit, indicating that the form is a bottleneck limiting the completion rate of the entire process.

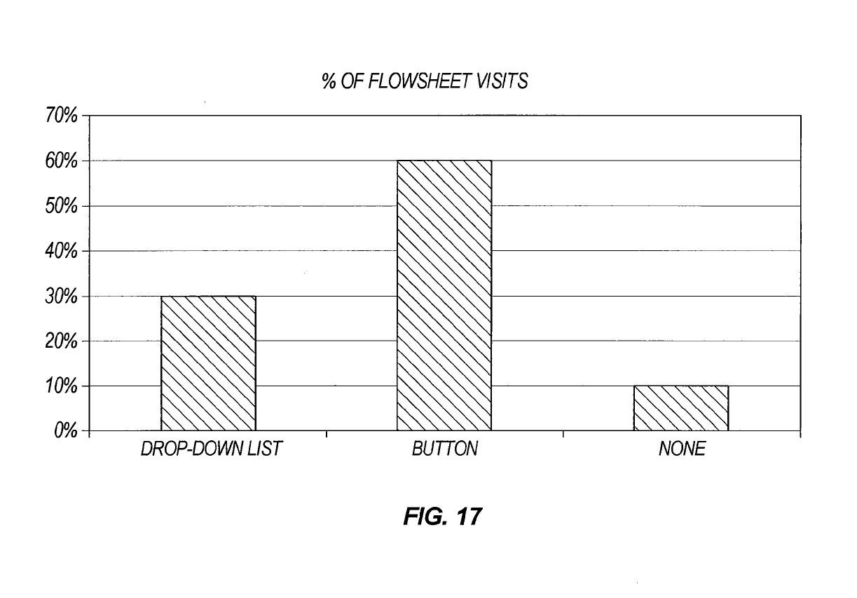

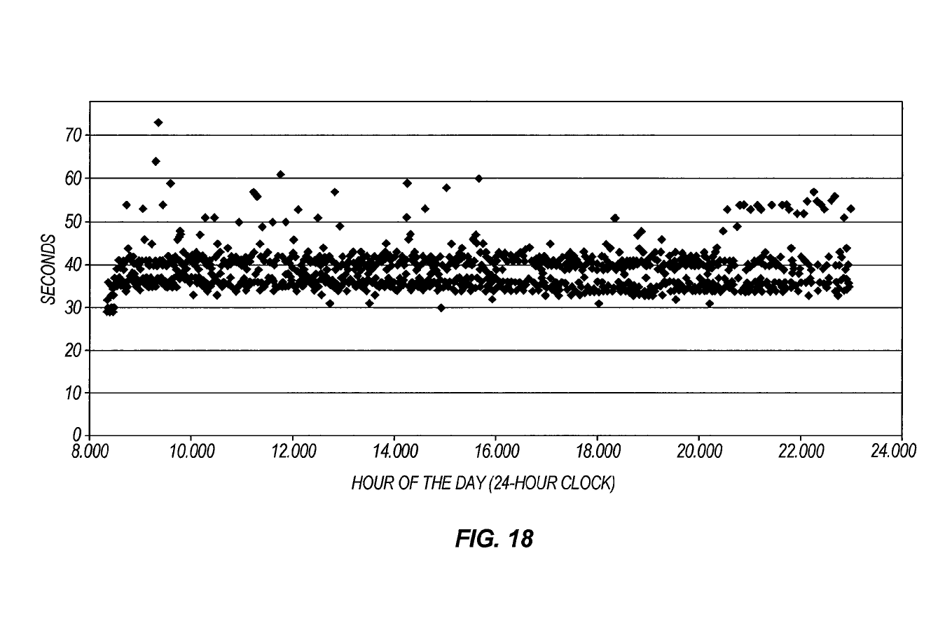

FIG. 17 shows an example report that illustrates the percentage of target application user visits to a “Flowsheet” target application form resulting in at least one occurrence of the three illustrated user-interface event types while the user interacts with that form. Also, for example, the analytics member 50 may generate time series data such as end-to-end completion time for a workflow, as shown in FIG. 18.

In still other exemplary embodiments, the analytics member 50 may utilize algorithms that look for generic indications of usage or usability problems that are not previously known such as, for example, occurrences of a target application user clicking many times more than the average user on certain target application windows.

Once the system 30 is capable of identifying user activity by capturing usage data within the target software application, the system 30 may analyze the usage data to deduce user behavior within one or more user sessions within the target software application. Examples of usage data that may be captured include, but are not limited to, the number of mouse clicks that users make in a user-interface element corresponding to a button displayed on a user-interface and gauging the frequency of use of that button, transitions between two forms displayable on a user-interface containing respective mapped elements may be linked to each other through a button and such transitions counted, user selections from a drop-down list may be extracted by performing OCR on a captured image of the mapped user-interface element containing the list's textbox, dwell times (time spent on a form displayed in the user-interface) may be calculated by comparing the timestamps of successive window-open events, instances of a user switching between the target software application and other applications may be detected by tracking window focus events, distribution of mouse clicks and even mouse “hovers” (sampling of mouse positions while mouse is moving) in a user-interface may be determined to see what portions of the user-interface are used the most, sophisticated path analytics may be applied to determine the most popular and least popular navigational paths through the target software application, correlation analysis may be applied to uncover correlations among target software application context and user behavior (e.g., how often a button is clicked depending upon values of text fields or other data displayed on the same user-interface), etc.

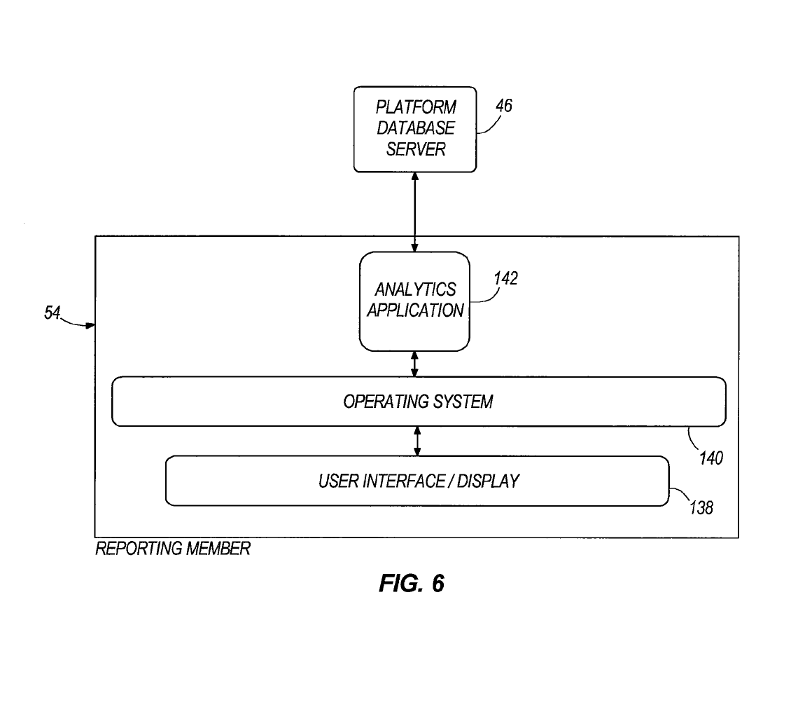

With continued reference to FIG. 1 and additional reference to FIG. 6, the exemplary system 30 may include an exemplary reporting member 54 and the exemplary reporting member 54 may include a user interface device or display 138, an operating system 140, an analytics application 142 (i.e., software), among other elements. In some exemplary embodiments, the operating system 140 may include both software and hardware elements such as, for example, operation software (e.g., Microsoft Windows, etc), a processor, memory, or any other software or hardware necessary to support operation of the reporting member 54. The reporting member 54 may generate human-readable reports communicating findings that are generated by and stored in the platform database server 46 by the analytics member 50. In some exemplary embodiments, the reporting member 54 may report on a sequential workflow 94 defined by the mapping workstation 58. More particularly, the reporting member 54 may utilize images of target application user-interface elements 78 captured by the mapping workstation 58. For example, with reference to FIG. 7, the reporting member 54 may superimpose visual indications 154 (e.g., a circle around the “New . . . ” button) on images of target application forms to associate a user action 126 with a particular step in a defined workflow 94, which may obviate the need for a report user to remember the textual description of the user action 126 corresponding to each step in the defined workflow 94.

It is very conceivable that attributes of a mapped user-interface element 78 in a target software application 34 may change. Such changes may occur in a variety of manners including, but not limited to, a target application software developer removing or repositioning child user-interface elements 78 within a parent mapped user-interface element 78 (e.g., within a target application window form), resizing or repositioning of a mapped user-interface element 78, changing to where a mapped user-interface element 78 navigates upon the user activating it, etc. When user-interface elements 78 change, the element map associated with the changed user-interface element 78 may become invalid.

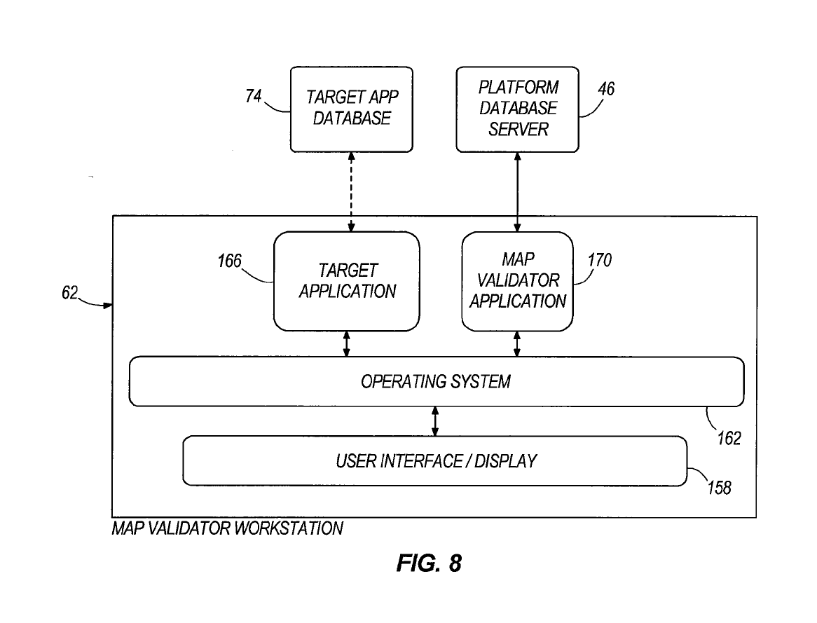

With continued reference to FIG. 1 and additional reference to FIG. 8, the exemplary system 30 may include an exemplary map validator workstation 62 and the exemplary map validator workstation 62 may include a user interface device or display 158, an operating system 162, a target application 166 (i.e., software), map validator application 170 (i.e., software), among other elements. In some exemplary embodiments, the operating system 162 may include both software and hardware elements such as, for example, operation software (e.g., Microsoft Windows, etc), a processor, memory, or any other software or hardware necessary to support operation of the map validator workstation 62. The map validator application 170 may access the target application 166 through the map validator workstation 62. In some exemplary embodiments, the map validator application 170 may automatically and periodically check validity of every element map by utilizing an automation component, which navigates the target software application to access all the mapped user-interface elements 78 whose element maps 130 are to be checked for validity. The automation component may navigate the target software application according to navigational instructions defined and stored in the platform database server by the mapping application, perhaps leveraging information about the navigational relationship among user-interface elements contained within element maps. A user may be able to access the user-interface of the mapping validator workstation to configure settings for the mapping validator application that will be used to direct the mapping validator application how to perform.

For each mapped user-interface element 78 to which the map validator application navigates, the map validator application uses attributes of the captured user-interface elements to construct a “presumed primary key” for the user-interface element's map. The map validator application attempts to retrieve an element map corresponding to that primary key from the platform database server 46. If an element map is found for the user-interface element 78, then the map validator compares the actual attributes of the user-interface element, captured at that moment, to those stored in the element map for that user-interface element. If the map validator detects any difference between the actual attributes and those stored in the element map, then the map validator application notifies the map validator user or other entity that has the ability to update the element map appropriately. This inhibits an invalid element map from being used to interpret captured user-interface events acting upon that user-interface element. Use of invalid element maps may lead to erroneous results and reports. Since all user-interface events are stored in the platform database server, an updated or new element map may be applied retroactively to analyzing past events to correct any analyses performed using an old, invalid element map.

In some instances, the map validator application may not be able to find a stored element map associated with a particular user-interface element of the target software application. In such instances, a change to a user-interface element may have occurred so that the presumed primary key does not match the primary key of any element map stored in the platform database server 46, or that at least one navigational relationship between two user-interface elements within the target software application has been changed so that the automation component is unable to reach the intended mapped user-interface element via the navigational information contained in the element maps or otherwise defined through the user-interface 158 of the map validator workstation 62. Other possibilities may exist that prevent the map validator application from finding a stored element map and such other possibilities are within the intended spirit and scope of the present invention. The map validator user or other entity that has the ability to update or add element maps is notified by the map validator application whenever the map validator application is unable to find a stored element map associated with a particular user-interface element of the target software application. The notification provides an opportunity for the user or other entity to update element maps, or the automation component's navigational instructions configured through the user interface 158 of the map validator workstation 62, that can rectify the relevant element maps or navigational instructions such that the map validator application is able to navigate to each mapped user-interface element 78 and construct a presumed primary key that matches the primary key for exactly one element map in the platform database server 46. Once such changes to the element map(s) and/or navigational instructions are made by the mapping application user and/or the map validator user, then he/she/they can initiate a re-analysis of past user-interface events stored in the platform database server 46 using any relevant, updated element maps.

With continued reference to FIG. 1 and additional reference to FIG. 20, the exemplary system 30 may include an exemplary platform database server 46 and the exemplary platform database server 46 may include a user interface device or display 174, an operating system 178, a platform database 182, among other elements. In some exemplary embodiments, the operating system 178 may include both software and hardware elements such as, for example, operation software (e.g., Microsoft Windows, etc), a processor, memory, or any other software or hardware necessary to support operation of the platform database server 46. The platform database 182 may have a variety of elements stored therein such as, for example, a library of element maps 130 (described in greater detail herein), which are illustrated in more detail in FIG. 21.

It should be understood that the exemplary systems of the present invention may have a variety of different configurations and elements, and may operate or function in a variety of different manners in order to monitor and enhance usage of target software applications. Such various configurations, elements, operations, and functions may be dependent upon the extent to which the agent(s), mapping application, and map validator application have access to the user-interface object model and/or user-interface event stream of the target software application. In the following exemplary embodiment, the agent(s), mapping application, and map validator only have access to certain attributes of mouse events and target application user-interface elements such as, for example, mouse click event types, mouse click positions, application form titles, application form pixel sizes, etc. Access to attributes of other user-interface elements and user-interface events via the user-interface object model and/or user-interface event stream of the target software application may be restricted. For example, such restricted access may apply to a target software application that is a Java applet, Microsoft Silverlight, or Macromedia Flash control, all of which produce only limited sets of user-interface element and event attributes accessible by the agent(s) 42, such that these attributes by themselves do not indicate for all user-interface events which user-interface elements were activated by users. For example, when a target application user clicks on a button within a Macromedia Flash control, the user-interface event stream accessible by an agent 42 may not itself indicate which button within that control was clicked. In such a situation, the agent 42 does not have access to a unique numerical identifier of the clicked user-interface element, unlike the case where the agent can access the full user-interface object model and event stream of a target application from which a unique programmatic ID of a clicked button may be derived. Another scenario in which access to the user-interface object model and/or user-interface event stream may be restricted is when the agent, mapping application, and map validator application only have access to a virtualized version of an application, which may occur when using target applications through virtualization technology such as, for example, Citrix ICA™ or Windows RDP. The systems of the present invention enable capture and interpretation of target software application usage in such scenarios when the target software application's user-interface object model and/or event stream are not fully accessible to the agent, mapping application, and/or map validator application. The following description is an exemplary manner in which the exemplary systems of the present invention are able to capture and interpret target software application in such scenarios.

With continued reference to FIG. 1 and FIG. 2, the agents 42 reside on target workstations 38, which enable users to use the target application, but which restrict the agents' access to attributes of the user-interface events and user-interface elements associated with those users' interaction with the target application. For example, if the workstation uses a Microsoft Windows operating system, then the agent could be implemented as a Windows “.exe” application that runs in the background, and the target application may be accessed through a Citrix ICA™ virtualization client. The agent 42 may be designed so that it would capture event data and save it into a flat text file that is periodically uploaded by the agent 42 to the platform database server 46 for subsequent analysis by the analytics member 50. Such an agent may capture certain, but not all, attributes of user-interface events and elements, such as event time-stamps, target application form titles, form pixel sizes, form positions relative to user-interface origin, form focus changes when users bring different forms to the foreground, mouse event positions, mouse event types, keyboard events, images of portions of user-interface elements, etc. The agent periodically uploads captured user-interface event data to the platform database server 46. In order to conserve storage space on each target workstation 38, a method, similar to that of a rotating-log method common among web servers for managing web log storage, may be used to limit the amount of user-interface event data locally stored on the workstation at any given time. The agent may be designed so that end users of the target software application do not experience any noticeable performance impacts on the functioning of the target software application.

With continued reference to FIG. 4, an exemplary manner of establishing a primary key for an element map is illustrated in an EHR related target software application. As indicated previously, the systems and methods of the present invention may be used with a wide variety of target software applications and the use of the EHR target software application is not intended to be limiting upon the present invention.

In the illustrated exemplary embodiment, the element map primary key for a user-interface element 78 may be constructed in the following way. The first component of the primary key is a textually-filtered version of the Form Title of the user-interface element's parent application form, or, if the user-interface element 78 is an application form, that of the user-interface element 78 itself. The second and third components of the primary key may be the Form Width and Form Height, respectively, of the user-interface element's parent form, or, if the user-interface element 78 is an application form, those of the user-interface element 78 itself. In order to distinguish element maps of user-interface elements 78 sharing the same values of these three primary key components, as is the case with all the child button and tab user-interface elements 78 in the application form in FIG. 4, the fourth primary key component may be a numerical value created by a mapping application number generator such that the combination of these four primary key components comprises a unique primary key for every element map for the target application. For example, the element map for the “Find Pt.” button may have a primary key composed of “CHART”+“640”+“780”+“4839201”, where each component corresponds in order to the four components described above. In the illustrated exemplary embodiment, the textually-filtered Form Title used in the element map primary key for the application form in FIG. 4 or for any of its child elements is “CHART”, which could be derived by the mapping application 98 applying a regular-expression filter to the Form Title to extract the word “CHART” from within the brackets in the Form Title. In the present example in FIG. 4, the agent 42 may extract the Form Height and Form Width of the application form as attributes of the user-interface event stream which the operating system makes accessible to the agent 42. In the illustrated exemplary embodiment in FIG. 4, some child user-interface elements of the application form are enclosed by the dashed borders in FIG. 4.

The mapping application 98, which may be implemented as a Microsoft Windows application or other such thick-client application, provides quick and convenient means for a mapping application user to define an element map for each user-interface element 78 he/she wishes to map. As indicated above, in this exemplary embodiment, the mapping application 98 only has limited access to attributes of the user-interface object model of the target software application. In particular, the mapping application 98 does not have access to unique programmatic IDs for many, if not all, of the user-interface elements 78 of the target application. Under these circumstances and, by example, for the “Find Pt.” button in FIG. 4, the mapping application 98 may enable a mapping application user to define components of an element map in the following exemplary manner.

Assume that the Form Title, Form Height, and Form Width of the target application form that is the parent element of the “Find Pt.” button are made accessible to the mapping application by the mapping workstation operating system, as is the case when the target application is accessed on the mapping workstation through a Citrix ICA™ virtualization client running on a Microsoft Windows operating system. Then, the mapping application can construct a primary key (element map component 1) for the button's element map by combining, via an algorithm, these three attributes of the button's parent form with an integer generated by a number generator within the mapping application that guarantees the resulting primary key is unique among those of all element maps for the target application. An example of such a primary key for this button was presented in one of the preceding paragraphs. Next, the mapping application could allow the mapping application user to capture and display a 1:1 pixel image of the entire application form, and then use the mouse to drag a bounding rectangle over the displayed form image that encompasses the region of the “Find Pt.” button, such as that indicated by the dashed rectangle surrounding the “Find Pt.” button in FIG. 4. Then, the mapping application may extract the height and width in pixels of that “Find Pt.” button region and store these dimensions as element attributes in element map component (2) (selected element attributes). The mapping application user may also define the semantic meaning of the “Find Pt.” button, stored in element map component (3), as “Find Patient Button”. Element map component (4) (rules for extracting input data values) may contain a rule created by the mapping application user directing the agent to extract and store the value of the “PATIENT ID” label field in the parent form, via image capture and OCR, whenever the “Find Pt.” button is clicked by the target application user. For defining Element map component (5) (rules for launching secondary applications), the mapping application user could define a rule directing the agent to launch a secondary application (e.g. implemented as a Windows .exe application) and pass the secondary application the extracted value of the “PATIENT ID” label field whenever the “Find Pt.” button is clicked. Element map component (6) (references to child element maps) may be empty because the “Find Pt.” button has no child user-interface elements. Element map component (7) (map links) may contain a navigational relationship expressing that a mouse click on the “Find Pt.” button displays another application form, whose element map is referenced in the definition of the navigational relationship.

Another example of an element map will be described herein and such an element map relates to the application form consuming the entire or substantially the entire user-interface in FIG. 4 and bounded by the largest dashed border in FIG. 4. This element map is unlike the element map for the “Find Pt.” button in at least two ways. First, the application form's element map component (6) is not empty, as it contains references to child element maps corresponding to the child user-interface elements surrounded by the dashed borders (other than the dashed border surrounding the largest or containing application form). Second, element map component (7) contains a map link defining a navigational relationship originating from a mouse click in a particular region of the containing application form, not just anywhere on the user-interface element as was the case with the “Find Pt.” button's element map component (7), which results in the display of the entirety of the “Summary” tab. In this case, the region in which a mouse click would display the entire “Summary” tab would be the area occupied by the upward extended portion of the “Summary” tab. FIG. 9 shows the “Flowsheet” tab, as another example of a child user-interface element whose element map would be referenced within both element map components (6) and (7) of the element map for the containing application form.

Continuing discussion of scenarios in which access to the target software application's user-interface object model and/or user-interface event stream may be restricted, Table A shows some example user-interface event data that may be captured by an agent operating under such scenarios. In some exemplary embodiments, multiple agents deployed across multiple workstations may capture the data illustrated in Table A and upload the data to the platform database server for further analysis. It should be understood that Table A is illustrated for exemplary purposes only and is not intended to be limiting upon the present invention. Many other types of data may be captured by one or more agents and the wide variety of captured data may be organized in a wide variety of different manners other than that illustrated in Table A. All of such different data and different organization manners are intended to be within the intended spirit and scope of the present invention.

TABLE A
Conceptual Example of User-Interface Event Data Captured By an Agent.

| | | | | | Form | | Event | | | |
|---|---|---|---|---|---|---|---|---|---|---|
| Event | | Form | Form | Form | Position | Event | Position | Key(s) | Element | Captured |
| ID (EID) | Event Time | Title | Height | Width | (x, y) | Type | (x, y) | Pressed | Map ID | Image(s) |
| 1 | 13:45:30.12 | ..[CHART].. | 640 | 780 | 201, 549 | Left | 323, 101 | | 423 | [symbol] |
| | | | | | | Click | | | | |
| 2 | 13:45:33.23 | ..[CHART].. | 640 | 780 | 201, 549 | Left | 162, 108 | | 432 | |
| | | | | | | Click | | | | |
| 3 | 13:45:33.49 | Find | 320 | 390 | 268, 562 | Window | | | | |
| | | Flowsheet | | | | Opened | | | | |
| | | View | | | | | | | | |
| 4 | 13:45:36.32 | Find | 320 | 390 | 268, 562 | Left | 562, 425 | | 420 | [symbol] |
| | | Flowsheet | | | | Click | | | | |
| | | View | | | | | | | | |
| 5 | 13:45:39.76 | ..[CHART].. | 640 | 780 | 201, 549 | Window | | | | |
| | | | | | | In Focus | | | | |

In the example shown in Table A, the Event ID (EID) uniquely identifies every captured user-interface event, certain attributes of which are captured by an agent and stored in each table row. In exemplary Table A and with respect to the target application form shown in FIG. 4, the agent captures from the user-interface event stream of the target workstation's operating system the following attributes of the event and the target application form upon which the user-interface event occurs: Event Time, Form Title, Form Height, Form Width, Form Position, Event Type, Event Position, and Key(s) Pressed. The element map component (4) of the element map of the user-interface element activated by the user-interface event may direct the agent to extract input data values from certain child user-interface elements by, for example capturing images of those child user-interface elements and applying optical character recognition (OCR) to extract those elements' input data values from those images. Alternatively, OCR can be applied later by the analytics member. If the agent captures such images upon the occurrence of a user-interface event, then the agent stores the element map's unique Element Map ID, which has a 1:1 correspondence to the element map's primary key, and the set of captured image(s) in the last two columns of the table, respectively. Rows with EID=2 and 8 exemplify the storage of images captured by an agent. It should also be understood that extraneous user events that do not accomplish any user task may be captured by an agent. For example, if the user were to accidentally click in a blank or meaningless area of the user-interface, then the target software application would take no action even though the click would be captured by the system. Such extraneous events are not shown in Table A and may be filtered out by the agent or during subsequent analysis by the analytics member. On the other hand, such events could be indications that the target software application design has usability issues if there is a preponderance, for example, of “wasted clicks” performed by users.

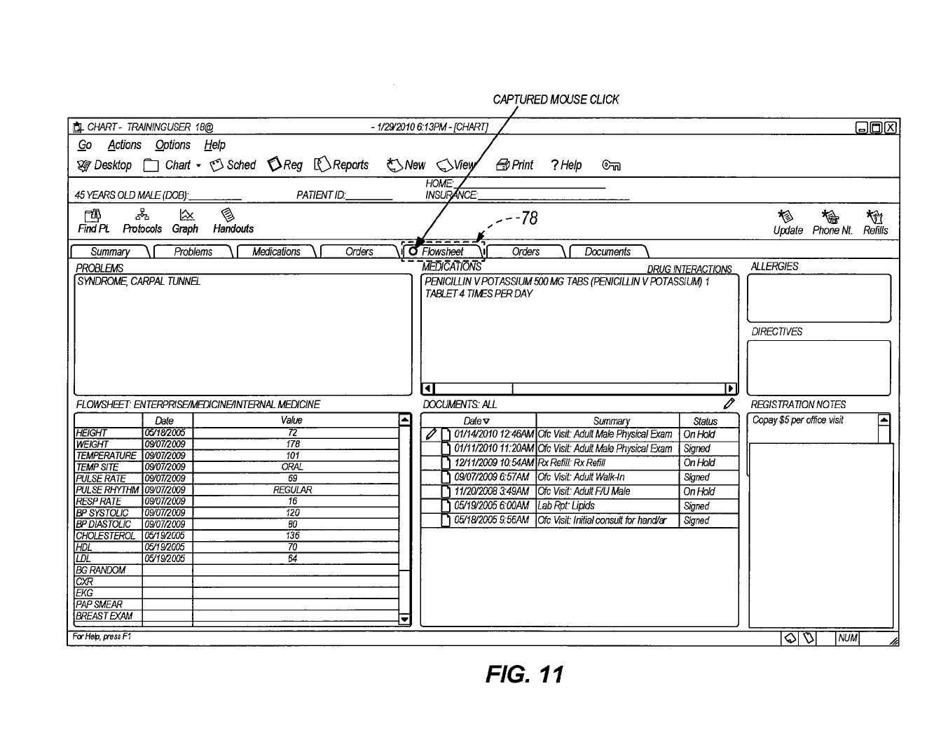

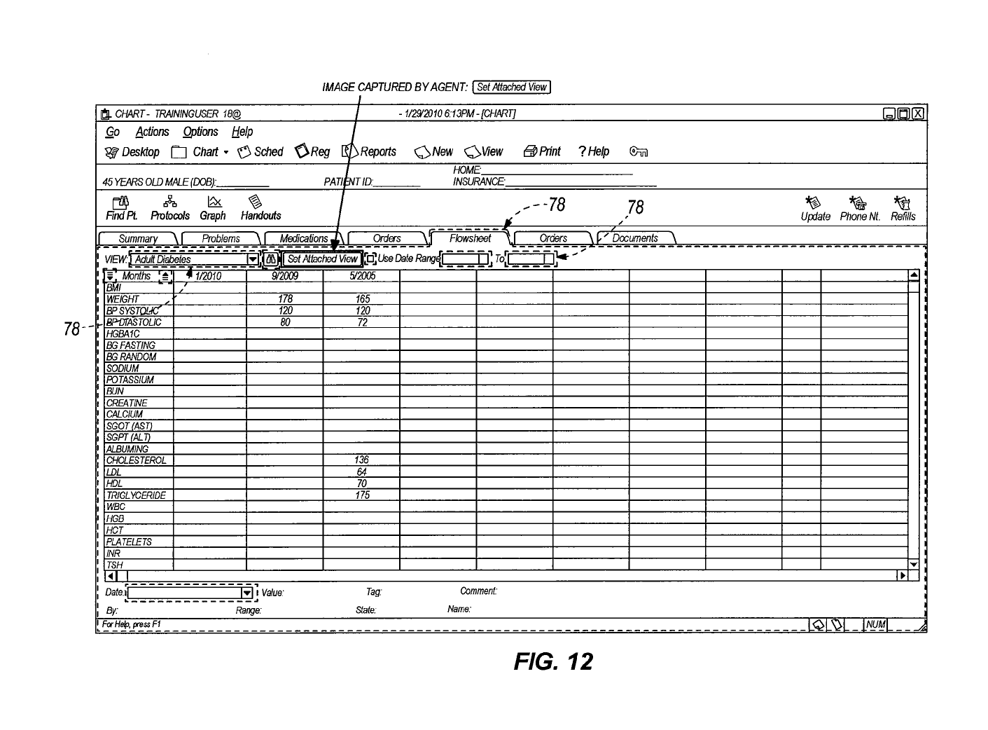

What follows are several examples of how the agent, or alternatively the analytics member, may retrieve element maps, and the semantic meanings of user-interface elements defined therein, based upon the event data shown in Table A. Assume that the agent has already retrieved the element map for the containing application form shown in FIG. 4. FIG. 10 shows that the target application user clicking the “Flowsheet” tab's upward extended portion results in the entire “Flowsheet” tab being shown (i.e., the upward extending portion and the lower portion below the upward extended portion). The user-interface event generated by the user clicking the “Find Pt.” button corresponds to EID=1 in Table A. The Form Title, Form Height, and Form Width are those of the containing application form. The Form Position is the position of the containing application form relative to the coordinate origin of the target workstation display. The Event Type is a left click of the mouse, occurring with the mouse at Event Position (323,101) relative to the coordinate origin of the target workstation display. The difference between the Event Position and the Form Position is equal to the position of the mouse click relative to the coordinate origin of the containing application form. The agent calculates this relative mouse click position and deduces from a map link, stored in the containing application form's element map component (7) (map links), that the mouse click occurred within a region defined through the mapping application that bounds the “Flowsheet” tab's upward extended portion (the bounding dashed border in FIG. 11), representing a user-interface event that opens the entire “Flowsheet” tab, whose element map is referenced by the aforementioned map link. The circle within the bounding dashed border in FIG. 11 indicates the location of the mouse click. The Element Map ID=423 in the corresponding row in Table A is that of the element map for the “Flowsheet” tab, some of whose child user-interface elements are shown bounded by dashed borders in FIG. 9. The “Flowsheet” tab's element map component (4) (rules for extracting input data values) contains a rule directing the agent to capture an image in real-time of the region bounding where the “Set Attached View” child button should be located on the tab; this image, depicted in FIG. 12, is stored in the “Captured Image(s)” column in Table A. Furthermore, the “Flowsheet” tab's element map component (5) (rules for launching secondary applications) specifies that the agent should launch a secondary application designed to verify that the “Flowsheet” tab was actually opened by the target application user. This secondary application compares the image stored in the “Captured Image(s)” column of Table A with the previously captured image of the “Set Attached View” mapped button stored in the element map (a reference to which is stored in the “Flowsheet” tab's element map component 6) for the button. If the images do not match, then the secondary application stores a notification in the platform database server, subsequently sent to or accessed by the mapping application user or other responsible person, indicating that the “Flowsheet” tab was not navigated to by the event with EID=1, possibly due to one or more element maps (such as that of the containing application form) being inaccurate. Hence, this secondary application serves as another means to validate element maps during target application usage by target application users rather than by an automation component as is used by the map validator application.

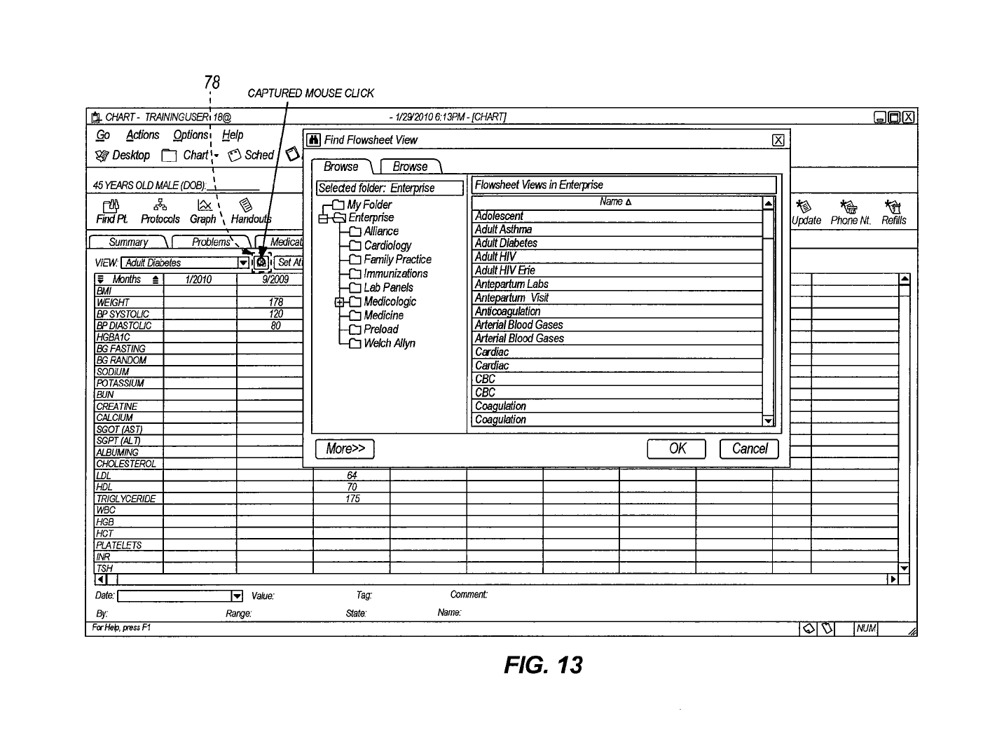

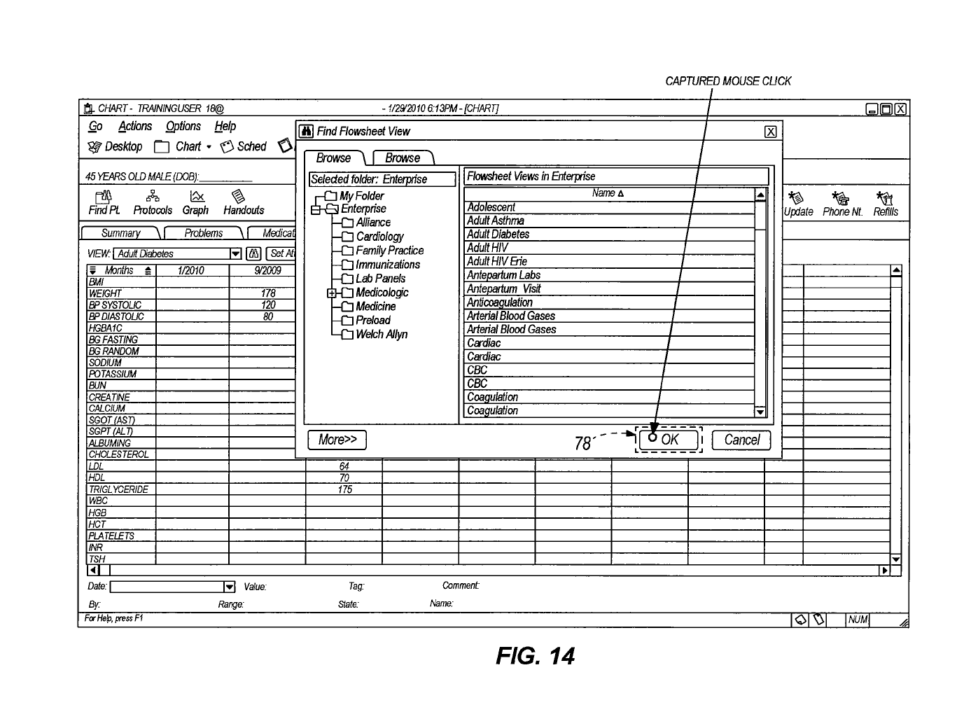

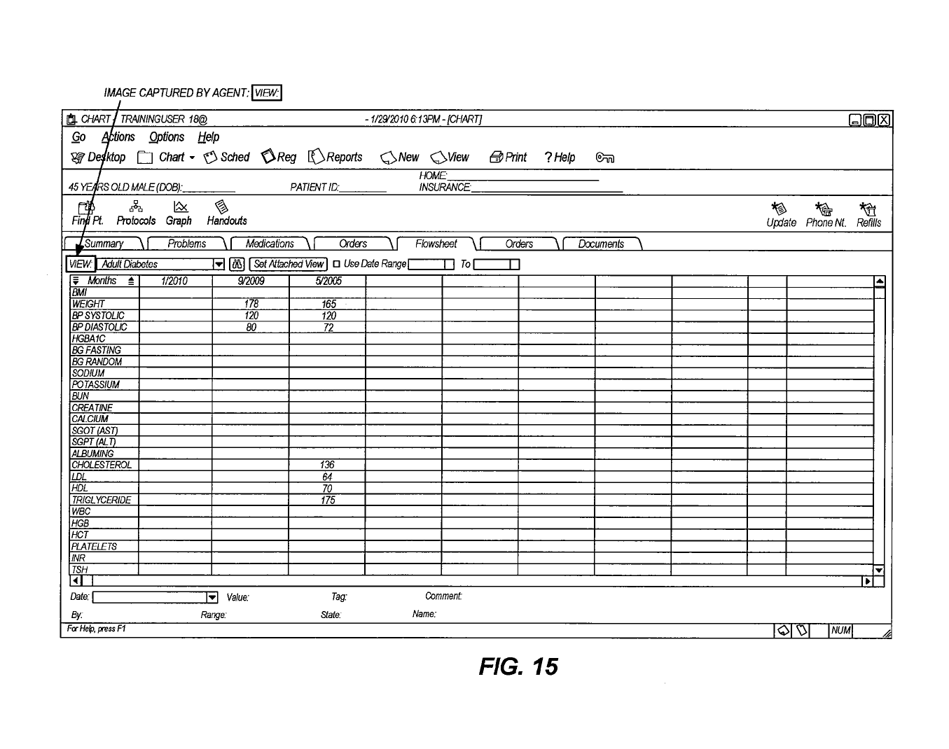

Continuing with reference to Table A, another navigational path depicted in FIG. 13 includes a mouse click on the indicated square button (containing binoculars, which generically represent a search) results in the opening of the “Find Flowsheet View” form, corresponding to events EID=2 and EID=3 in Table A. Event EID=2 is the captured mouse click, where the Element Map ID=432 is that of the “Find Flowsheet View” element map, which can be retrieved by the agent or by the analytics member through using the map link information contained in element map component (7) (map links) for the “Flowsheet” tab. The agent or analytics member is able to determine that the mouse click is occurring on the “Flowsheet” tab because it knows from event EID=1 that the “Flowsheet” tab has been opened and the mouse click is in the “Flowsheet” tab's active region, which is defined by coordinates as tab attributes stored in element map component (2) (element attributes) of the element map for the “Flowsheet” tab. Event EID=3 is a “Window Opened” user-interface event generated by the target workstation upon the “Find Flowsheet View” form opening. Event EID=4 is a mouse click on the “OK” button on the “Find Flowsheet View” form (shown in FIG. 14), which closes the form and generates a “Window In Focus” user-interface event (EID=5), indicating that the containing application form has returned to the foreground of the display, as shown in FIG. 15. For EID=4, the Element Map ID=420 is that of the containing application form's element map, whose element map components (4) and (5) direct the agent to capture an image of the region bounding the “VIEW” label, as shown in FIG. 15, and launch the same secondary application mentioned in the previous paragraph to validate that the “Flowsheet” tab is still the opened tab.

As described previously, secondary applications may be implemented to reduce a user's clicks or keystrokes. Implementations of such secondary applications may be accomplished using common software automation development tools such as, for example, MacroScheduler, which enables rapid development of automation components compiled into self-contained Windows.exe applications. Furthermore, the agent may launch these or other secondary applications through standard operating system calls such as, for example, those provided by the Microsoft Windows operating system application programming interface (API).

The agent may need to determine in real-time how and when to launch secondary applications. The real-time nature of this activity may require that, upon the capture of a user-interface event, the agent retrieves and stores in local workstation memory the relevant element map and all of its child element maps prior to the occurrence of the next user-interface event. When a subsequent user-interface event acts upon one of the corresponding child user-interface elements, the agent may immediately retrieve the element maps from local workstation memory without incurring network latencies enabling fast processing of the secondary application launch rules contained. Data required from any other remote databases for the rules processing may also be fetched ahead of time for the same reason. Input data values from user-interface elements such as, for example, textboxes and list boxes, may be extracted by the agent using the information contained in the relevant element map and OCR. The agent may also extract input data values from user-interface elements encountered previously and store these data values locally on the target workstation.

Referring back to FIG. 1, reference is made again to the analytics member 50, capable of analyzing user-interface event data, and the reporting member 54, capable of producing human-readable reports of the analysis results generated by the analytics member. With additional reference to FIG. 5, the analytics application 136 may be implemented as a software component, written in a programming language such as C++ or C#, deployed on a Microsoft Windows or Linux server operating system. In addition, the analytics application 136 may utilize platform database queries, written in a query language such as SQL, to search for particular user-interface events or usage patterns in the user-interface event data collected by the agent 42 and stored in the platform database server 46. Alternatively, sophisticated analyses may be accomplished by the analytics member 50 offloading some processing to an existing analytics tool such as SAS or SPSS. Furthermore, the exemplary embodiments of the analytics member 50 previously described above may be implemented in one or more of the aforementioned fashions. Exemplary reports illustrated in FIG. 7, FIG. 16, FIG. 17, and FIG. 18 (previously explained above) may, within this embodiment, be implemented as web-based reports generated by the reporting member 54 and accessed through an internet browser. Further, for example, the reporting member 54 may also be capable of creating other report formats similar to those generated by reporting products such as Crystal Reports or Jasper Reports. The exemplary reporting member 54 embodiments described herein are only some of many different possible reporting members 54, all of which are intended to be within the intended spirit and scope of the present invention. Additionally, the exemplary reports referenced above generated by the exemplary reporting member 54 are exemplary and are not intended to limiting. The reporting member 54 is capable of generating a wide variety of different types of reports, all of which are intended to be within the intended spirit and scope of the present invention.

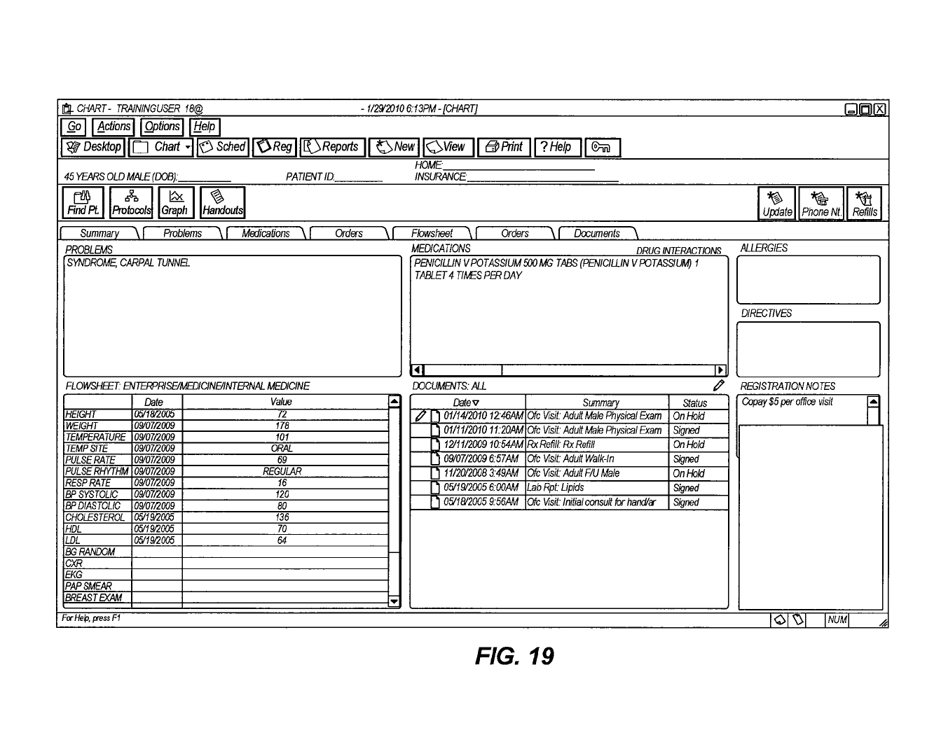

With continued reference to FIG. 1 and additional reference to FIG. 8, the map validator application 170 may be implemented as a Microsoft Windows application or other such thick-client application. Its automation component could be implemented as a MacroScheduler .exe application or other such application compiled from an automation scripting development tool. The solid rectangular borders in FIG. 19 indicate images of child user-interface elements of the containing application form that the map validator application 170 may capture in order to compare against the images of those child elements stored in the relevant child element maps referenced by the element map for the containing application form. Should one or more of the images captured by the map validator application 170 not match the corresponding image stored in the relevant element map, the map validator application 170 will notify the map validator user and/or the mapping application user that one or more invalid element map(s) exist(s).

Furthermore, if a map link defining navigation from a user-interface event to a user-interface element is invalid, as would happen, for example, if a target application developer changed the destination form of a button, then an invalid map link would be detected by the map validator application 170 since the new destination form associated with the map link would not match the original destination form whose element map is referenced in the map link.

Since the map validator application 170 navigates the target software application, the map validator may be required to enter certain input field values in order to reach target windows. In order to prevent the automation component of the map validator application from making material changes to the target application's database content, it may be necessary to setup test data and/or test user accounts in the target application database for the automation component of the map validator application to manipulate without impacting real data. Furthermore, the map validator application may be configured to wake-up at regular intervals to automatically navigate through the target application, perform element map validations, and send email notifications to responsible parties should one or more element maps be found to be invalid.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention.

1. A method associated with a software application, the method comprising:
providing the software application;
providing a first workstation including a first user interface, wherein the first workstation is adapted to access the software application;
providing a second workstation including a second user interface, wherein the second workstation is adapted to access the software application;
displaying a first area of interest and a second area of interest associated with the software application on the first user interface of the first workstation;
displaying the first area of interest and the second area of interest associated with the software application on the second user interface of the second workstation;
defining the first area of interest as a first user-interface element with the second workstation;
assigning a first element map to the first user-interface element with the second workstation;
defining the second area of interest as a second user-interface element with the second workstation; and
assigning a second element map to the second user-interface element with the second workstation, wherein the first element map is different than the second element map.

2. A system associated with a software application, the system comprising:
the software application;
a first workstation including a first user interface, wherein the first workstation is adapted to access the software application, and wherein a first area of interest and a second area of interest associated with the software application are displayable on the first user interface of the first workstation; and
a second workstation including a second user interface, wherein the second workstation is adapted to access the software application and wherein the first area of interest and the second area of interest associated with the software application are displayable on the second user interface of the second workstation, wherein the second workstation is adapted to define the first area of interest as a first user-interface element and assign a first element map to the first user-interface element, and wherein the second workstation is adapted to define the second area of interest as a second user-interface element and assign a second element map to the second user-interface element, wherein the first element map is different than the second element map.

3. The system of claim 2, wherein the second workstation includes an input device, and wherein the input device is used to define the first and second areas of interest as the first and second user-interface elements.

4. The system of claim 3, wherein the system does not have access to source code of the software application.

5. The system of claim 4, wherein the system does not modify source code of the software application.

6. The system of claim 3, wherein the input device is used to assign the first and second element maps to the first and second user-interface elements.

7. The system of claim 6, wherein the system does not have access to source code of the software application.

8. The system of claim 7, wherein the system does not modify source code of the software application.

9. The system of claim 3, wherein the input device of the second workstation is used to define a first geometric region enclosing the first area of interest and a second geometric region enclosing the second area of interest, wherein the first geometric region is associated with the first user-interface element and the second geometric region is associated with the second user-interface element.

10. The system of claim 9, wherein the first geometric region includes a first attribute and the second geometric region includes a second attribute, and wherein the first attribute comprises at least a portion of the first element map and the second attribute comprises at least a portion of the second element map.

11. The system of claim 10, wherein the first element map includes a first primary key and the second element map includes a second primary key, and wherein the first primary key is generated by an algorithm of the second workstation by utilizing at least one attribute of the first user-interface element, and wherein the second primary key is generated by the algorithm of the second workstation by utilizing at least one attribute of the second user-interface element.

12. The system of claim 10, wherein the first element map includes a first primary key and the second element map includes a second primary key, and wherein the first primary key is generated by an algorithm of the second workstation by utilizing at least one attribute of a first parent user-interface element of the first user-interface element, and wherein the second primary key is generated by the algorithm of the second workstation by utilizing at least one attribute of a second parent user-interface element of the second user-interface element.

13. The system of claim 10, wherein the first element map includes a first primary key and the second element map includes a second primary key, wherein the first primary key is generated by an algorithm of the second workstation by utilizing at least one attribute of a first child user-interface element of the first user-interface element, and wherein the second primary key is generated by the algorithm of the second workstation by utilizing at least one attribute of a second child user-interface element of the second user-interface element.

14. The system of claim 10, wherein the first element map includes a first primary key and the second element map includes a second primary key, and wherein the first primary key is at least partially comprised of a first number assigned by the second workstation, and wherein the second primary key is at least partially comprised of a second number assigned by the second workstation.

15. The system of claim 10, wherein the first element map includes a first primary key and the second element map includes a second primary key, and wherein the first primary key is at least partially comprised of a first number assigned by a number generator of the second workstation, and wherein the second primary key is at least partially comprised of a second number assigned by the number generator of the second workstation.

16. The system of claim 2, wherein the second workstation automatically defines the first and second areas of interest as the first and second user-interface elements.

17. The system of claim 16, wherein the first user-interface element includes a first attribute and the second user-interface element includes a second attribute, and wherein the second workstation automatically captures the first attribute of the first user-interface element and the second attribute of the second user-interface element, and wherein the second workstation populates the first element map with the first captured attribute and populates the second element map with the second captured attribute.

18. The system of claim 17, wherein the first element map includes a first primary key and the second element map includes a second primary key, and wherein the first primary key is generated by an algorithm of the second workstation by utilizing at least one attribute of the first user-interface element, and wherein the second primary key is generated by the algorithm of the second workstation by utilizing at least one attribute of the second user-interface element.

19. The system of claim 17, wherein the first element map includes a first primary key and the second element map includes a second primary key, and wherein the first primary key is generated by an algorithm of the second workstation by utilizing at least one attribute of a first parent user-interface element of the first user-interface element, and wherein the second primary key is generated by the algorithm of the second workstation by utilizing at least one attribute of a second parent user-interface element of the second user-interface element.

20. The system of claim 17, wherein the first element map includes a first primary key and the second element map includes a second primary key, wherein the first primary key is generated by an algorithm of the second workstation by utilizing at least one attribute of a first child user-interface element of the first user-interface element, and wherein the second primary key is generated by the algorithm of the second workstation by utilizing at least one attribute of a second child user-interface element of the second user-interface element.

21. The system of claim 17, wherein the first element map includes a first primary key and the second element map includes a second primary key, and wherein the first primary key is at least partially comprised of a first number assigned by the second workstation, and wherein the second primary key is at least partially comprised of a second number assigned by the second workstation.

22. The system of claim 17, wherein the first element map includes a first primary key and the second element map includes a second primary key, and wherein the first primary key is at least partially comprised of a first number assigned by a number generator of the second workstation, and wherein the second primary key is at least partially comprised of a second number assigned by the number generator of the second workstation.

23. A system associated with a software application, the system comprising:
the software application;
a database including a plurality of element maps stored therein, each element map including at least one attribute and at least one image;
a workstation adapted to access the software application and including a user-interface and an input device, wherein a user-interface element associated with the software application is displayed on the user-interface, and wherein a user-interface event occurs in association with the user interface element; and
an agent associated with the workstation, wherein the agent
captures at least one attribute of the user-interface event,
captures an image of the user-interface element,
searches the database for one of the plurality of element maps having an attribute similar to the at least one captured attribute and an image similar to the captured image of the user interface element,
identifies the one of the plurality of element maps having an attribute similar to the captured attribute and an image similar to the captured image of the user interface element, and
associates the identified one of the plurality of element maps with the user-interface element.

24. The system of claim 23, wherein the user-interface event is performed by a user on the user interface element with the input device.

25. The system of claim 23, wherein the agent is installed on the workstation.

26. The system of claim 23, wherein each element map includes a plurality of attributes and at least one image, and wherein the agent
captures a plurality of attributes of the user-interface event,
searches the database for one of the plurality of element maps having a plurality of attributes similar to the captured plurality of attributes and an image similar to captured image of the user interface element,
identifies the one of the plurality of element maps having a plurality of attributes similar to the plurality of captured attributes and an image similar to the captured image of the user interface element, and
associates the identified one of the plurality of element maps with the user-interface element.

27. The system of claim 23, wherein the captured attribute of the user-interface event is a primary key.

28. The system of claim 23, wherein the captured attribute of the user-interface event is a pixel size of the user-interface element.

29. The system of claim 23, wherein the captured attribute of the user-interface event is a pixel location of the user-interface element.

30. The system of claim 23, wherein the system does not have access to source code of the software application.

31. The system of claim 30, wherein the system does not modify source code of the software application.

32. The system of claim 31, wherein the system has access to information about the software application only available to an end user of the software application.

33. The system of 23, wherein each element map includes a plurality of images, and wherein the agent
captures a plurality of images of the user-interface element,
searches the database for one of the plurality of element maps having an attribute similar to the at least one captured attribute and a plurality of images similar to the captured plurality of images of the user interface element,
identifies the one of the plurality of element maps having an attribute similar to the captured attribute and a plurality of images similar to the captured plurality of images of the user interface element, and
associates the identified one of the plurality of element maps with the user-interface element.

34. A system associated with a software application, the system comprising:
the software application;
a database;
a first workstation adapted to access the software application, generate at least one rule associated with the software application, and store the at least one rule in the database;
a second workstation adapted to access the software application and including an input device, a user-interface and a user-interface element associated with the software application displayed on the user-interface, the user-interface element including a data field; and
an agent associated with the second workstation, wherein, upon a user-interface event, the agent retrieves the at least one rule from the database, and based on the retrieved rule the agent extracts data from the data field of the user-interface element.

35. The system of claim 34, wherein the agent is installed on the second workstation.

36. The system of claim 34, wherein the first workstation includes a user-interface and an input device.

37. The system of claim 34, wherein the user-interface event is performed by a user with the input device.

38. The system of claim 34, wherein the user-interface event automatically occurs.

39. The system of claim 34, wherein the system does not have access to source code of the software application.

40. The system of claim 39, wherein the system does not modify source code of the software application.

41. The system of claim 34, wherein an element map is stored in the database, and wherein the element map includes the at least one generated rule.

42. A system associated with a software application, the system comprising:
the software application;
a database;
a first workstation adapted to access the software application, generate at least one rule associated with the software application, and store the at least one rule in the database;
a second workstation adapted to access the software application and including a user-interface and a user-interface element associated with the software application displayed on the user-interface; and
an agent associated with the second workstation, wherein, upon a user-interface event, the agent retrieves the at least one rule from the database, and based on the retrieved rule the agent launches a secondary application.

43. The system of claim 42, wherein the agent is installed on the second workstation.

44. The system of claim 42, wherein the first workstation includes a user-interface and an input device.

45. The system of claim 42, wherein the user-interface event is performed by a user with the input device.

46. The system of claim 42, wherein the user-interface event automatically occurs.

47. The system of claim 42, wherein the system does not have access to source code of the software application.

48. The system of claim 47, wherein the system does not modify source code of the software application.

49. The system of claim 42, wherein an element map is stored in the database, and wherein the element map includes the at least one generated rule.

50. The system of claim 42, wherein the agent captures at least one attribute of the user-interface event and communicates the at least one captured attribute to the secondary application such that the secondary application can use the at least one captured attribute.

51. A system associated with a software application, the system comprising:
the software application;
a first workstation including a first user interface, wherein the first workstation is adapted to access the software application, and wherein a first area of interest and a second area of interest associated with the software application are displayable on the first user interface of the first workstation; and
a second workstation including a second user interface, wherein the second workstation is adapted to access the software application and wherein the first area of interest and the second area of interest associated with the software application are displayable on the second user interface of the second workstation, wherein the second workstation is adapted to define the first area of interest as a first user-interface element and assign a first element map to the first user-interface element, and wherein the second workstation is adapted to define the second area of interest as a second user-interface element and assign a second element map to the second user-interface element;
wherein the first element map is different than the second element map; and
wherein the second user-interface element is displayable as a result of a user-interface event occurring in association with the first user-interface element.

52. The system of claim 51, wherein the first element map includes a first map link, and wherein the first map link includes a user-interface event and a primary key of the second user-interface element.

53. The system of claim 52, wherein, when the user-interface event occurring in association with the first user-interface element is similar to the user-interface event of the first map link, the second element map of the second user-interface element is retrieved.

54. The system of claim 51, wherein the system does not have access to source code of the software application.

55. The system of claim 54, wherein the system does not modify source code of the software application.

56. A system associated with a software application, the system comprising:
the software application;
a first workstation including a first user interface and a first input device, wherein the first workstation is adapted to access the software application, and wherein the first workstation defines a user action sequence associated with the software application and comprised of at least one user action;
a second workstation including a second user interface and a second input device, wherein the second workstation is adapted to access the software application, and wherein at least one user action associated with the software application may be performed on the second workstation;
an agent associated with the second workstation and adapted to capture data associated with each user action performed on the second workstation; and
an analytics member adapted to analyze the data captured by the agent to determine correspondence of the at least one user action performed on the second workstation with the user action sequence defined by the first workstation.

57. The system of claim 56, wherein a user is capable of using the first input device to define the user action sequence.

58. The system of claim 56, wherein the at least one user action is performed by a user using the second input device.

59. The system of claim 56, wherein the agent is installed on the second workstation.

60. The system of claim 56, wherein the system does not have access to source code of the software application.

61. The system of claim 56, wherein the system does not modify source code of the software application.

62. The system of claim 56, wherein the analytics member is adapted to analyze the data captured by the agent to determine a level of compliance of the at least one user action performed on the second workstation with the user action sequence defined by the first workstation.

63. The system of claim 62, wherein the level of compliance may be represented in a graphical manner.

64. The system of claim 62, wherein the level of compliance may be represented in a numerical manner.

65. The system of claim 56, wherein a user action is comprised of a user-interface element and a user-interface event occurring in association with the user-interface element.

66. The system of claim 56, wherein the user action sequence is comprised of a plurality of user actions, wherein a plurality of user actions associated with the software application may be performed on the second workstation, and wherein the analytics member is adapted to analyze the data captured by the agent to determine correspondence of the plurality of user actions performed on the second workstation with the user action sequence defined by the first workstation.

67. A system associated with a software application, the system comprising:
the software application;
a database including a plurality of stored element maps stored in the database;
a workstation adapted to access the software application and including a user-interface adapted to display a user-interface element associated with the software application, wherein the user-interface element has a user-interface element map associated therewith, and wherein the workstation
navigates the software application to the user-interface element,
accesses the user-interface element map associated with the user-interface element,
compares the accessed user-interface element map with the plurality of stored element maps to determine correspondence between the accessed user-interface element map and the plurality of stored element maps, and
provides a notification if the accessed user-interface element map does not correspond to any of the plurality of stored element maps.

68. The system of claim 67, wherein the system does not have access to source code of the software application

69. The system of claim 67, wherein the system does not modify source code of the software application.

70. The system of claim 67, wherein the workstation is a first workstation, the system further comprising a second workstation including a user-interface and an input device, and wherein the plurality of stored element maps are at least partially created by the second workstation.

71. The system of claim 70, wherein the second workstation defines a navigational path through the software application and the first workstation navigates the software application according to the navigational path.

72. The system of claim 71, wherein the first workstation includes an automation component allowing the first workstation to automatically navigate the software application according to the navigational path.

73. The system of claim 67, wherein the workstation includes an automation component allowing the workstation to automatically navigate the software application to the user-interface element.

74. The system of claim 67, wherein the workstation provides the notification by displaying the notification on the user-interface of the workstation.

75. The system of claim 67, wherein each of the stored element maps includes a plurality of attributes and the accessed user-interface element map includes a plurality of attributes, and wherein the workstation constructs a presumed primary key for the accessed user-interface element from the attributes of the accessed user-interface element map.

76. The system of claim 75, wherein the workstation attempts to retrieve a stored element map from the plurality of stored element maps that corresponds to the presumed primary key.
